(19) United States
(12) Patent Application Publication
(10) Pub. No.: US 2026/0081312 A1
(43) Pub. Date: Mar. 19, 2026

(54) BATTERY, JOINING JIG, JOINING APPARATUS, AND MANUFACTURING METHOD OF BATTERY

(71) Applicant: Kabushiki Kaisha Toshiba, Kanagawa (JP)

(72) Inventors: Takahiro Aizawa, Yokohama Kanagawa (JP); Yuto Shinohara, Yokosuka Kanagawa (JP)

(21) Appl. No.: 19/304,986

(22) Filed: Aug. 20, 2025

(30) Foreign Application Priority Data
Sep. 19, 2024 (JP) 2024-162503

(51) Int. Cl. H01M 50/536; B23K 20/00; B23K 20/10; B23K 101/36; H01M 50/533; H01M 50/538

(52) U.S. Cl. CPC H01M 50/536; B23K 20/002; B23K 20/10; H01M 50/533; H01M 50/538; B23K 2101/36

(57) ABSTRACT

A battery of an embodiment includes an electrode group, a lead, a groove, and a concave structure, and the electrode group includes a current collecting bundle protruding toward one side in a length direction. The lead is joined to the current collecting bundle with being stacked on the current collecting bundle from one side in a thickness direction of the electrode group crossing the length direction. The groove is depressed to a groove bottom toward a side on which the lead is located in the thickness direction in a joint part between the lead and the current collecting bundle. The concave structure includes one or more concave portions each further depressed from the groove bottom toward the side on which the lead is located, and the groove bottom neighbors the concave structure from a side opposite to a protruding side of the current collecting bundle in the length direction.

### CROSS-REFERENCE TO RELATED APPLICATIONS

This application is based upon and claims the benefit of priority from Japanese Patent Application No. 2024-162503, filed Sep. 19, 2024; the entire contents of which are incorporated herein by reference.

### FIELD

Embodiments described herein relate generally to a battery, a joining jig, a joining apparatus, and a manufacturing method of a battery.

### BACKGROUND

A battery such as a lithium-ion secondary battery includes an electrode group that includes a positive electrode and a negative electrode. Each of the positive electrode and negative electrode in the electrode group includes a current collector, in which a current collecting bundle in which a plurality of current collecting strips are bundled is formed. In the electrode group of the battery, the current collecting bundle of the current collector protrudes toward one side in a length direction, and is electrically connected to a terminal via a lead, etc. The current collecting bundle is joined to the lead by ultrasonic welding or the like, and a joint part between the current collecting bundle and the lead is formed in the battery.

In manufacturing of the battery, the current collecting bundle is joined to the lead by using a joining jig in which one or more projections of a convex structure protrude. In the joining of the current collecting bundle to the lead, the lead is stacked on the current collecting bundle from one side in a thickness direction of the electrode group, and a joined target part, in which the current collecting bundle and the lead are stacked, is interposed between the joining jig and a stage. The lead and the current collecting bundle are joined by, for example, transmitting ultrasonic vibration to the joined target part through the joining jig with the joined target part interposed between the joining jig and the stage. In the state in which the joining of the joined target part is being performed, one or more projections of the convex structure are brought into contact with the joined target part from an opposite side to a stacking side of the lead. Thus, in the joint part between the lead and the current collecting bundle, a concave portion that is depressed toward a side on which the lead is located is formed in each of the parts with which the one or more projections are brought into contact, and a concave structure is formed by one or more concave portions.

In the case where the current collecting bundle is joined to the lead, as described above, there is a demand for ensuring suitable joining between the lead and the current collecting bundle, etc. at the joint part. In particular, there is a demand for ensuring suitable joining at a region that neighbors the concave structure on a side opposite to a protruding side of the current collecting bundle. In the joint part between the lead and the current collecting bundle, etc., in a region that neighbors the concave structure on the side opposite to a protruding side of the current collecting bundle, there is a demand for suitably suppressing warping of the current collecting bundle, etc. toward a side opposite to a side on which the lead is located in the thickness direction.

### BRIEF DESCRIPTION OF THE DRAWINGS

FIG. 1 is a schematic diagram showing an example of a configuration of a battery according to a first embodiment.

FIG. 2 is a schematic diagram showing an example of a configuration of an electrode group in the battery according to the first embodiment.

FIG. 3 is a schematic diagram showing an example of a configuration of a joint part in which a single current collecting bundle of the electrode group is joined to a lead, and a vicinity thereof, in the battery according to the first embodiment, as viewed from one side in a thickness direction of the electrode group.

FIG. 4 is a cross-sectional view schematically showing a cross section along an imaginary line A1 in FIG. 3.

FIG. 5 is a cross-sectional view schematically showing a cross section along an imaginary line A2 in FIG. 3.

FIG. 6 is a schematic diagram showing an example of a configuration of a joining apparatus used in the manufacturing of the battery according to the first embodiment.

FIG. 7 is a perspective view schematically showing an example of a configuration of a joining tip portion of a joining jig according to the first embodiment.

FIG. 8 is a schematic view showing an example of a state in which a single current collecting bundle of the electrode group is joined to the lead according to the first embodiment, in a cross section perpendicular to or substantially perpendicular to a width direction of the electrode group.

FIG. 9 is a schematic diagram showing the state in FIG. 8, in a cross section perpendicular to or substantially perpendicular to a length direction of the electrode group.

FIG. 10 is a schematic diagram showing an example of a configuration of a joint part in which a single current collecting bundle of an electrode group is joined to a lead, and a vicinity thereof, in a battery according to a first modification.

FIG. 11 is a schematic diagram showing an example of a configuration of a joint part in which a single current collecting bundle of an electrode group is joined to a lead, and a vicinity thereof, in a battery according to a second modification.

FIG. 12 is a schematic diagram showing an example of a configuration of a joint part in which a single current collecting bundle of an electrode group is joined to a lead, and a vicinity thereof, in a battery according to a third modification, as viewed from one side in a thickness direction of the electrode group.

FIG. 13 is a cross-sectional view schematically showing a cross section along an imaginary line A3 in FIG. 12.

FIG. 14 is a perspective view schematically showing an example of a configuration of a joining tip portion of a joining jig according to the third modification.

### DETAILED DESCRIPTION

A battery of an embodiment includes an electrode group, a lead, a groove, and a concave structure, and the electrode group includes a current collecting bundle protruding toward one side in a length direction. The lead has electrical conductivity, and is joined to the current collecting bundle in a state of being stacked on the current collecting bundle from one side in a thickness direction of the electrode group, which crosses the length direction of the electrode group. The groove includes a groove bottom, and is depressed to the groove bottom toward a side on which the lead is located in the thickness direction, in a joint part between the lead and the current collecting bundle. The concave structure includes one or more concave portions each further depressed from the groove bottom of the groove toward the side on which the lead is located, and the groove bottom of the groove neighbors the concave structure from a side opposite to the protruding side of the current collecting bundle in the length direction.

Hereinafter, an embodiment will be described with reference to the accompanying drawings.

### First Embodiment

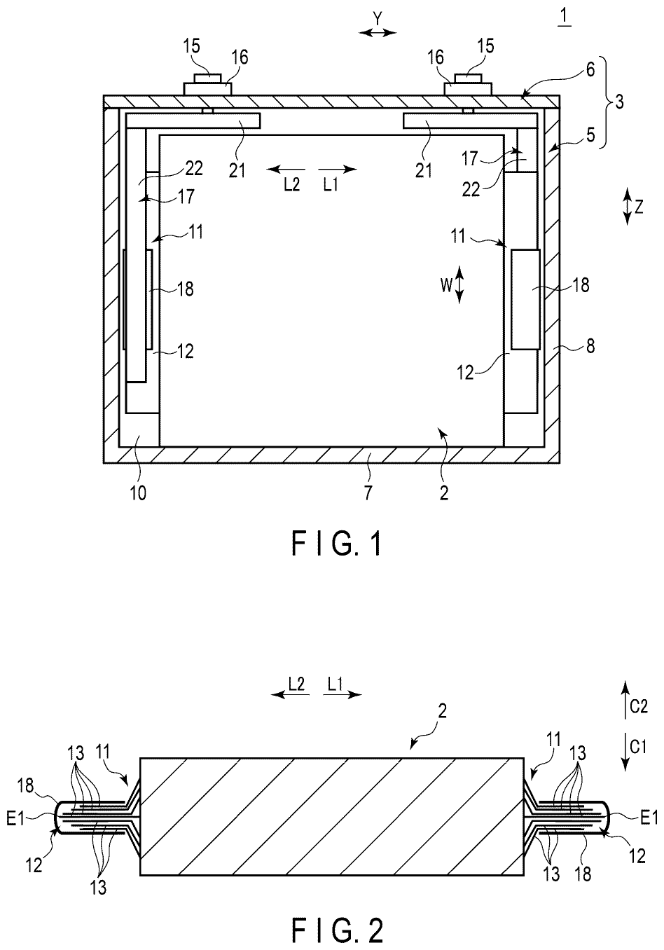

FIG. 1 is a schematic diagram showing an example of a configuration of a battery 1 according to a first embodiment. The battery 1 in the example of FIG. 1 includes an electrode group 2 and an exterior unit 3. The exterior unit 3 includes an exterior container 5 and a lid member 6. In the battery 1 and the exterior unit 3, a depth direction (a direction perpendicular to or substantially perpendicular to the drawing sheet of FIG. 1), a lateral direction (as indicated by an arrow Y) crossing (perpendicular to or substantially perpendicular to) the depth direction, and a height direction (as indicated by an arrow Z) crossing (perpendicular to or substantially perpendicular to) both the depth direction and the lateral direction, are defined. In each of the battery 1 and the exterior unit 3, a dimension along the depth direction is smaller than a dimension along the lateral direction and a dimension along the height direction. Note that FIG. 1 illustrates a cross section perpendicular to or substantially perpendicular to the depth direction.

The exterior container 5 includes a bottom wall 7 and a peripheral wall 8. In the inside of the exterior container 5, an inner cavity 10 in which the electrode group 2 is accommodated is defined by the bottom wall 7 and the peripheral wall 8. In the exterior container 5, the inner cavity 10 opens toward a side opposite to a side on which the bottom wall 7 is located in the height direction. The lid member 6 is attached to the peripheral wall 8 at an end portion on a side opposite to the bottom wall 7. Thus, the lid member 6 closes the opening of the inner cavity 10 of the exterior container 5. The lid member 6 and the bottom wall 7 face each other, with the inner cavity 10 interposed therebetween.

The electrode group 2 includes a positive electrode and a negative electrode. In the electrode group 2, a separator is intervened between the positive electrode and the negative electrode. In the electrode group 2, the separator is formed of a material having an electrical insulation property, and electrically insulates the positive electrode from the negative electrode. In the electrode group 2, the positive electrode includes a positive-electrode current collector such as a positive-electrode current collecting foil, and a positive-electrode active material-containing layer coated (supported) on a surface of the positive-electrode current collector. The positive-electrode current collector includes an uncoated part 11 on which the positive-electrode active material-containing layer is not coated (not supported). In the electrode group 2, the negative electrode includes a negative-electrode current collector such as a negative-electrode current collecting foil, and a negative-electrode active material-containing layer coated (supported) on a surface of the negative-electrode current collector. The negative-electrode current collector includes an uncoated part 11 on which the negative-electrode active material-containing layer is not coated (not supported). In the electrode group 2 with the above-described configuration, the uncoated part 11 of the positive electrode and the uncoated part 11 of the negative electrode 11 are formed as a pair of uncoated parts 11. Note that the uncoated part 11 of the positive electrode is also referred to as a “positive-electrode uncoated part”, and the uncoated part 11 of the negative electrode is also referred to as a “negative-electrode uncoated part”.

FIG. 2 is a schematic diagram showing an example of a configuration of the electrode group 2 in the battery 1 according to the first embodiment. As shown in FIGS. 1 and 2, in the electrode group 2, a length direction (as indicated by arrows L1 and L2), a width direction (as indicated by an arrow W) crossing (perpendicular to or substantially perpendicular to) the length direction, and a thickness direction (as indicated by arrows C1 and C2) crossing (perpendicular to or substantially perpendicular to) both the length direction and the width direction, are defined. In the electrode group 2, a dimension along the thickness direction is smaller than a dimension along the length direction and a dimension along the width direction. Note that in FIG. 1, the electrode group 2 as viewed from one side in the thickness direction is shown, and in FIG. 2, the electrode group 2 in a cross section perpendicular to or substantially perpendicular to the width direction is shown.

In one example, the electrode group 2 is formed in a so-called winding structure, in which a positive electrode, a negative electrode, and a separator are wound around a winding axis, with the separator intervened between the positive electrode and the negative electrode. In this case, the winding axis of the winding structure in the electrode group 2 extends along the length direction of the electrode group 2. In another example, the electrode group 2 is formed in a so-called stack structure, in which a plurality of positive-electrode plates and a plurality of negative-electrode plates are alternately stacked in the thickness direction of the electrode group 2. In this case, in the electrode group 2, the positive electrode is configured of the plurality of positive-electrode plates, and the negative electrode is configured of the plurality of negative-electrode plates. The plurality of positive-electrode plates and the plurality of negative-electrode plates are stacked, with the separator intervened between the positive-electrode plate and the negative-electrode plate neighboring each other in the thickness direction (stacking direction).

In the inner cavity 10, an electrolytic solution (not illustrated) is held (impregnated) in the electrode group 2. The electrolytic solution may be an aqueous electrolytic solution such as an aqueous solution, or may be a nonaqueous electrolytic solution including an electrolyte dissolved in an organic solvent. In place of the electrolytic solution, a gel electrolyte or a solid electrolyte may be used. In a case where a solid electrolyte is used as the electrolyte, the separator may be formed of a solid electrolyte in the electrode group 2. A gas release valve and a liquid filling port may be formed in the lid member 6 of the exterior unit 3. In this case, a sealing plate for closing the liquid filling port is welded on an outer surface of the lid member 6. Note that the gas release valve and the liquid filling port may not be provided in the battery 1.

In the example of FIGS. 1 and 2, in the electrode group 2, the positive-electrode uncoated part (the uncoated part 11 of the positive electrode) protrudes toward one side in the length direction of the electrode group 2. In the electrode group 2, the negative-electrode uncoated part (the uncoated part 11 of the negative electrode) protrudes toward a side opposite to a protruding side of the positive-electrode uncoated part in the length direction. In each of the paired uncoated parts 11, a current collecting bundle 12 is formed. In the example of FIGS. 1 and 2, a single current collecting bundle 12 is formed in each of the positive-electrode uncoated part and the negative-electrode uncoated part. Each of the current collecting bundles 12 includes a plurality of current collecting strips 13. In each of the current collecting bundles 12, the current collecting strips 13 are bundled in a state of being stacked in the thickness direction of the electrode group 2. Thus, the stacking direction of the current collecting strips 13 in each of the current collecting bundles 12 is identical to or substantially identical to the thickness direction of the electrode group 2.

In the current collecting bundle 12 of the positive-electrode uncoated part, each of the bundled current collecting strips 13 is formed of a positive-electrode current collector. In the current collecting bundle 12 of the negative-electrode uncoated part, each of the bundled current collecting strips 13 is formed of a negative-electrode current collector. In the electrode group 2, the current collecting bundle 12 of the positive-electrode uncoated part protrudes toward one side in the length direction, and the current collecting bundle 12 of the negative-electrode uncoated part protrudes toward a side opposite to the protruding side of the positive-electrode uncoated part in the length direction.

In the battery 1 in the example of FIG. 1, the electrode group 2 is accommodated in the inner cavity 10 with the thickness direction of the electrode group 2 extending along a depth direction of the battery 1, and a length direction of the electrode group 2 extending along a lateral direction of the battery 1. The electrode group 2 is disposed in the inner cavity 10 with a width direction of the electrode group 2 extending along a height direction of the battery 1. Since the electrode group 2 is disposed in the inner cavity 10 in this manner, the battery 1 in the example of FIG. 1 is configured in such a manner that the current collecting bundle 12 of the positive-electrode uncoated part protrudes toward one side in the lateral direction, and the current collecting bundle 12 of the negative-electrode uncoated part protrudes toward a side opposite to the protruding side of the positive-electrode uncoated part in the lateral direction.

In the battery 1 in the example of FIG. 1, a pair of terminals 15 are attached to the lid member 6. Each of the paired terminals 15 is exposed to the outside of the battery 1, and is disposed on an outer surface of the lid member 6. The terminals 15 are formed of an electrically conductive material such as metal. One of the paired terminals 15 functions as a positive-electrode terminal of the battery 1, and the other of the paired terminals 15, which is different from the positive-electrode terminal, functions as a negative-electrode terminal of the battery 1. In the example of FIG. 1, an insulating member 16 is disposed between each of the paired terminals 15 and the lid member 6 on the outer surface of the lid member 6. Each of the paired terminals 15 is electrically insulated from the exterior unit 3 including the exterior container 5 and the lid member 6 by the insulating member 16.

In the example of FIG. 1, a pair of leads 17 are accommodated in the inner cavity 10 of the exterior unit 3. Each of the leads 17 is formed of an electrically conductive material and has electrical conductivity. One of the paired leads 17 functions as a positive-electrode lead, and the other of the paired leads 17, which is different from the positive-electrode lead, functions as a negative-electrode lead. In the battery 1, the positive-electrode terminal is connected to the positive-electrode lead, and the negative-electrode terminal is connected to the negative-electrode lead. In the battery 1, the current collecting bundle 12 of the positive-electrode uncoated part is joined (connected) to the positive-electrode lead, and is electrically connected to the positive-electrode terminal via the positive-electrode lead. The current collecting bundle 12 of the negative-electrode uncoated part is joined (connected) to the negative-electrode lead, and is electrically connected to the negative-electrode terminal via the negative-electrode lead. Accordingly, in each of the paired uncoated parts 11, the current collecting bundle 12 is joined (connected) to a corresponding one of the paired leads 17.

In the example of FIGS. 1 and 2, in each of the paired uncoated parts 11, a clip (a backup lead) 18 is attached to the current collecting bundle 12. Each of the clips 18 is formed of an electrically conductive material. In each of the uncoated parts 11, the current collecting bundle 12 is joined (connected) to a corresponding one of the paired leads 17 via a clip 18. Note that in the inner cavity 10 of the exterior container 5, the paired uncoated parts 11, the paired leads 17, and the clips 18 are electrically insulated from the exterior unit 3 including the exterior container 5 and the lid member 6 by one or more insulating members (not illustrated).

In the battery 1 in the example of FIG. 1, each of the paired leads 17 includes a top plate 21 and a leg plate 22, and a single leg plate 22 is formed in each of the leads 17. In the inner cavity 10, the top plate 21 of each lead 17 is disposed between the lid member 6 and the electrode group 2 in the height direction of the battery 1. In each of the leads 17, the leg plate 22 is connected to the top plate 21. In the inner cavity 10, the leg plate 22 in each lead 17 extends along the height direction of the battery 1 from a position of connection to the top plate 21 toward the side on which the bottom wall 7 is located.

In the battery 1, the leg plate 22 of the positive-electrode lead is joined to the current collecting bundle 12 and the clip 18 in a state of being stacked on the current collecting bundle 12 of the positive-electrode uncoated part from one side in the thickness direction of the electrode group 2 (the depth direction of the battery 1). In the battery 1, the leg plate 22 of the negative-electrode lead is joined to the current collecting bundle 12 and the clip 18 in a state of being stacked on the current collecting bundle 12 of the negative-electrode uncoated part from one side in the thickness direction of the electrode group 2. Thus, in each of the paired leads 17, the leg plate 22 functions as a joint plate to which a corresponding one of the current collecting bundles 12 is joined. In each of the leads 17, the leg plate 22 functioning as the joint plate is joined (connected) to a corresponding one of the current collecting bundles 12, in a state of being stacked on the corresponding one of the current collecting bundles 12 from one side in the thickness direction of the electrode group 2.

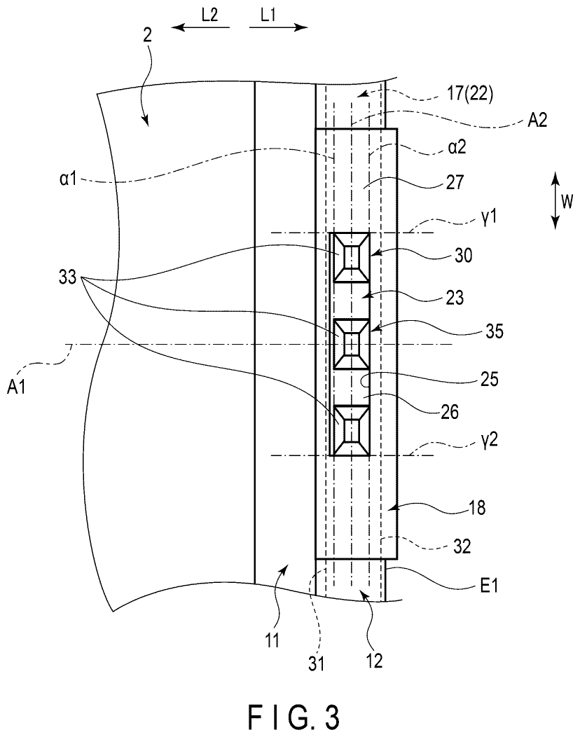

FIG. 3 is a schematic diagram showing an example of a configuration of a joint part (a connection part) in which one of the current collecting bundles 12 of the electrode group 2 is joined to a lead 17, and a vicinity thereof, in the battery 1 according to the first embodiment, as viewed from one side in the thickness direction of the electrode group 2. FIG. 3 shows the battery 1 as viewed from one side in the depth direction of the battery 1 (the stacking direction of the current collecting strips 13), showing a state as viewed from a side opposite to a stacking side of the lead 17 (leg plate 22) in the thickness direction of the electrode group 2.

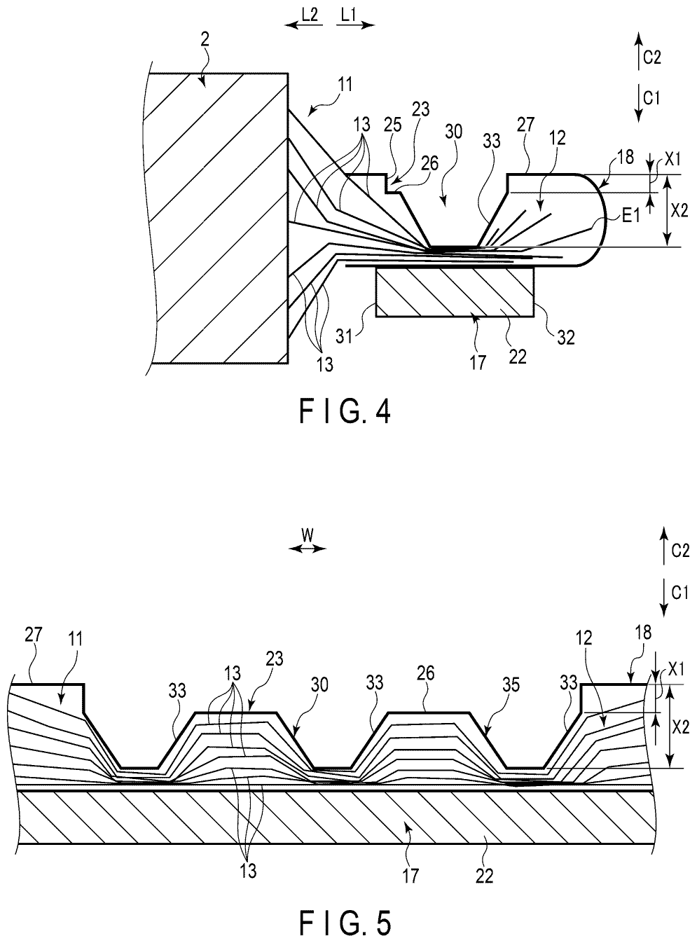

FIG. 4 is a cross-sectional view schematically showing a cross section along an imaginary line A1 in FIG. 3. FIG. 5 is a cross-sectional view schematically showing a cross section along an imaginary line A2 in FIG. 3. FIG. 4 shows a configuration of a joint part in which a single current collecting bundle 12 is joined to the lead 17 and the vicinity thereof, in a cross section perpendicular to or substantially perpendicular to the width direction of the electrode group 2 (to the height direction of the battery 1). FIG. 5 shows a configuration of a joint part in which a single current collecting bundle 12 is joined to the lead 17 and the vicinity thereof, in a cross section perpendicular to or substantially perpendicular to a length direction (a protruding direction of the current collecting bundle 12 and the lateral direction of the battery 1) of the electrode group 2.

Hereinafter, a configuration and the like of the joint part (a connection part) in which one of the current collecting bundles 12 is joined to the lead 17 will be described. In the battery 1, in each of the positive-electrode uncoated part and the negative-electrode uncoated part, the configuration and the like of the joint part in which the current collecting bundle 12 is joined to the lead 17 is similar to the configuration and the like to be described below.

As shown in FIGS. 3 to 5, etc., in the joint part (connection part) in which the current collecting bundle 12, the lead 17, and the clip 18 are joined, and the vicinity thereof, the clip 18 interposes the current collecting bundle 12 from both sides in the thickness direction of the electrode group 2 (the stacking direction of the current collecting strips 13). The clip 18 is attached to the current collecting bundle 12 in a state of being brought close to a protruding end E1 of the current collecting bundle 12 from the protruding side of the current collecting bundle 12 (from an outer side in the length direction of the electrode group 2). In a cross section perpendicular to or substantially perpendicular to the width direction of the electrode group 2, the clip 18 has a U shape or an approximate U shape (see FIGS. 2 and 4). The U shape or approximate U shape of the clip 18 is open toward the inner side in the length direction of the electrode group 2, that is, toward the side opposite to the protruding side of the current collecting bundle 12 (toward the side of the arrow L2 in FIGS. 3 and 4).

In the example of FIGS. 3 to 5, etc., the leg plate 22 of the lead 17 is stacked on the current collecting bundle 12 and the clip 18 from one side (the side of the arrow C1 in FIGS. 4 and 5) in the thickness direction of the electrode group 2. The leg plate 22 of the lead 17 is joined (connected) to the current collecting bundle 12 and clip 18 in a state of being stacked on the current collecting bundle 12 and the clip 18. In the joint part and the vicinity thereof, the lead 17 abuts on the clip 18 from one side in the thickness direction of the electrode group 2. The leg plate 22 is joined to the current collecting bundle 12 with the plate width direction extending along the length direction of the electrode group 2 (the protruding direction of the current collecting bundle 12), and the plate thickness direction extending along the thickness direction of the electrode group 2 (the stacking direction of the current collecting strips 13).

A groove 23 is formed in the joint part between the lead 17 and the current collecting bundle 12. The groove 23 includes a groove peripheral surface 25 and a groove bottom (groove bottom surface) 26. The groove 23 is depressed to the groove bottom 26 toward the lead 17, namely, toward a side on which the lead 17 is located (toward the side of the arrow C1) in the thickness direction of the electrode group 2. The groove 23 is open toward a side opposite to the side on which the lead 17 is located in the thickness direction of the electrode group 2. An edge of an opening of the groove 23 is formed by the groove peripheral surface 25. A reference surface 27, which faces the side opposite to the stacking side of the lead 17 in the thickness direction of the electrode group 2, is formed on an outer surface of the clip 18. In the example shown in FIGS. 3 to 5, the groove 23 opens in the reference surface 27 of the clip 18. The groove 23 is depressed from the reference surface 27 toward the locating side of the lead 17, and a step is formed by the groove peripheral surface 25 between the reference surface 27 and the groove bottom 26.

The leg plate (joint plate) 22 of the lead 17 includes a pair of plate edges 31 and 32 that form both edges in the plate width direction. In the leg plate 22, the plate edge (first plate edge) 31 forms an edge on one side in the plate width direction, and the plate edge (second plate edge) 32 forms an edge on an opposite side to the plate edge 31 in the plate width direction. In the leg plate 22 joined to the current collecting bundle 12, the plate edge 31 is located at a position farther distanced from the protruding end E1 of the current collecting bundle 12 than the plate edge 32. In other words, in the joint part and the vicinity thereof, the plate edge 31 is located on the side opposite to the protruding side of the current collecting bundle 12 (toward the side of the arrow L2 in FIGS. 3 and 4), with respect to the plate edge 32.

In the preferable example as shown in FIGS. 3-5, the joint part is configured in such a manner that the entirety of the groove 23 including the groove bottom 26 is located on the protruding side of the current collecting bundle 12 (on the outer side in the length direction of the electrode group 2), with respect to the plate edge 31 of the leg plate 22. Thus, in the joint part, the groove 23 (the groove peripheral surface 25 and the groove bottom 26) does not stick out (does not protrude), beyond the lead 17, to the side opposite to the protruding side of the current collecting bundle 12 in the length direction of the electrode group 2.

Also, in the preferable example as shown in FIGS. 3-5, the joint part is configured in such a manner that the entirety of the groove 23 is located on the side opposite to the protruding side of the current collecting bundle 12 (the inner side in the length direction of the electrode group 2), with respect to the plate edge 32 of the leg plate 22. Thus, in the joint part, the groove 23 does not stick out (does not protrude), beyond the lead 17, to the protruding side of the current collecting bundle 12 in the length direction of the electrode group 2, either. Accordingly, in a preferable example, the joint part is configured in such a manner that the entirety of the groove 23 falls within a range between the plate edges 31 and 32 of the leg plate 22 in the length direction of the electrode group 2.

In the present embodiment, a concave structure 30 is formed in the joint part so as to be depressed from the groove bottom 26. The concave structure 30 includes and is configured of one or more concave portions 33. Each of the concave portions 33 is further depressed from the groove bottom 26 of the groove 23 toward the side on which the lead 17 is located in the thickness direction of the electrode group 2. In the joint part, a depression amount X1 from the reference surface 27 to the groove bottom 26 of the groove 23, and a depression amount X2 from the reference surface 27 to the bottom of each of the concave portions 33 are defined. In the present embodiment with the above-described configuration, the depression amount X2 of each of the concave portions 33 is greater than the depression amount X1 to the groove bottom 26 of the groove 23.

In one example, each of the concave portions 33 does not reach the lead 17, and the bottom of each concave portion 33 is located at a position close to the reference surface 27, with respect to the lead 17. In another example, each of the concave portions 33 is depressed from the groove bottom 26 to the lead 17. Each of the concave portions 33 is formed, for example, in a polygonal pyramid shape, a polygonal truncated pyramid shape, a conical shape, a truncated conical shape, or a shape similar thereto.

In the example shown in FIGS. 3 to 5, the concave structure 30 is configured of a plurality of (e.g., three) concave portions 33. The plurality of concave portions 33 are aligned along the width direction of the electrode group 2, and form a single concave portion string 35. In the concave structure 30 (concave portion string 35) in the example shown in FIGS. 3 to 5, the plurality of concave portions 33 are not displaced or not substantially displaced from each other in the length direction of the electrode group 2. Thus, the plurality of concave portions 33 that form the concave portion string 35 have equal or substantially equal separation distances from the protruding end E1 of the current collecting bundle 12 along the length direction of the electrode group 2. In the example of FIGS. 3 to 5, only one concave portion string 35 is formed in the concave structure 30. Thus, the concave portions 33 that configure the concave structure 30 have equal or substantially equal separation distances from the protruding end E1 of the current collecting bundle 12 along the length direction of the electrode group 2.

In the present embodiment, the groove bottom 26 of the groove 23 neighbors the concave structure 30 from the side opposite to the protruding side of the current collecting bundle 12 in the length direction. Thus, the groove 23 stick out, beyond the concave structure 30, to the side opposite to the protruding side of the current collecting bundle 12 (to the inner side in the length direction of the electrode group 2). In the example shown in FIGS. 3-5, the groove bottom 26 neighbors the concave portion string 35 from the side opposite to the protruding side of the current collecting bundle 12, and neighbors each of the concave portions 33 configuring the concave portion string 35 from the side opposite to the protruding side of the current collecting bundle 12.

Accordingly, in the present embodiment, the groove bottom 26 extends to a region on the inner side (the side opposite to the protruding side of the current collecting bundle 12) in the length direction of the electrode group 2, with respect to an end of the concave structure 30 on the side opposite to the protruding side of the current collecting bundle 12. In the concave structure 30, a position through which an imaginary line α1 (see FIG. 3) passes, for example, forms the end on the side opposite to the protruding side of the current collecting bundle 12. In the preferable example as shown in FIGS. 3-5, the groove 23 does not stick out, beyond the lead 17, to the side opposite to the protruding side of the current collecting bundle 12 in the length direction of the electrode group 2, as described above. Accordingly, in the preferable example, the groove bottom 26 extends between the plate edge 31 of the lead 17 and the end of the concave structure 30 through which the imaginary line α1 passes.

In the preferable example as shown in FIGS. 3-5, the groove 23 (the groove bottom 26) does not stick out, beyond the concave structure 30, to the protruding side of the current collecting bundle 12. That is, the groove 23 does not stick out, beyond an end of the concave structure 30 on the protruding side of the current collecting bundle 12, to the outer side in the length direction of the electrode group 2 (to the protruding side of the current collecting bundle 12). In the concave structure 30, a position through which an imaginary line α2 (see FIG. 3) passes, for example, forms an end on the protruding side of the current collecting bundle 12. In the example shown in FIGS. 3-5, the groove 23 does not stick out, to the protruding side of the current collecting bundle 12 beyond the concave portion string 35, and does not stick out to the protruding side of the current collecting bundle 12 beyond each of the concave portions 35 configuring the concave portion string 35.

In the preferable example as shown in FIGS. 3-5, the groove 23 (groove bottom 26) does not stick out in the width direction of the electrode group 2 beyond the concave structure 30. Thus, the groove 23 is not formed in a region on an outer side of the concave structure 30 in the width direction of the electrode group 2. In the concave structure 30, for example, a position through which an imaginary line γ1 (see FIG. 3) passes forms one end in the width direction of the electrode group 2, and a position through which an imaginary line γ2 (see FIG. 3) passes forms the other end in the width direction of the electrode group 2. In a preferable example, the groove 23 does not stick out to an outer side of the imaginary lines γ1 and γ2 in the width direction of the electrode group 2. In the example shown in FIGS. 3-5, the groove 23 does not stick out to either side of the concave portion string 35 in the width direction. That is, the groove 23 does not stick out to an outer side with respect to each of the concave portions 33 located at both ends in the width direction of the electrode group 2, among the concave portions 33 configuring the concave portion string 35.

As described above, in the preferable example as shown in FIGS. 3-5, in a configuration in which the groove bottom 26 of the groove 23 neighbors the concave structure 30 from a side opposite to the protruding side of the current collecting bundle 12 in the length direction, the groove (groove bottom 26) sticks out, beyond the concave structure 30, only to the side opposite to the protruding side of the current collecting bundle 12. The groove 23 does not stick out, beyond the concave structure 30, to the protruding side of the current collecting bundle 12, or to either side in the width direction.

Also, in the example shown in FIGS. 3 to 5, each of the concave portions 33 in the concave portion string 35 is spaced apart from a neighboring concave portion 33. In the joint part, the groove bottom 26 of the groove 23 extends between concave portions 33 neighboring each other in the width direction of the electrode group 2 in the concave portion string 35. Thus, in the example shown in FIGS. 3 to 5, the concave portions 33 configuring the concave structure 30 include two or more concave portions 33 distanced from each other in the width direction of the electrode group 2. The groove bottom 26 of the groove 23 extends between the two or more concave portions 33 distanced from each other in the width direction. In the example shown in FIGS. 3-5, the groove bottoms 26 and the concave portions 33 are alternately disposed along the width direction of the electrode group 2 (along the alignment direction in the concave portion string 35) in a part in which the concave portion string 35 is to be formed.

In the manufacturing of the battery 1 with the above-described configuration, after the electrode group 2 is formed, the current collecting bundle 12 is joined to a corresponding one of the paired leads 17 by ultrasonic welding or the like in each of the paired uncoated parts 11 of the electrode group 2. At this time, the lead 17 is stacked on the current collecting bundle 12 from one side in the thickness direction of the electrode group 2 in each of the uncoated parts 11. Thereafter, the current collecting bundle 12 is joined to the lead 17 in each of the uncoated parts 11 by joining a joined target part in which the lead 17 and the current collecting bundle 12 are stacked. After that, each of the paired uncoated parts 11 is electrically connected to a corresponding one of the paired terminals 15 via a corresponding one of the leads 17.

In one example, each of the paired uncoated parts 11 is joined to a corresponding one of paired leads 17, with a corresponding one of the paired terminals 15 being connected to the corresponding one of the leads 17. In another example, each of the paired uncoated parts 11 is joined to a corresponding one of the paired leads 17, and then a corresponding one of the paired terminals 15 is connected to the corresponding one of the leads 17.

In the manufacturing of the battery 1 in the example of FIG. 1, the electrode group 2, the paired leads 17, etc. are accommodated in the inner cavity 10 of the exterior container 5, with each of the paired uncoated parts 11 being electrically connected to the corresponding one of the paired terminals 15 via the corresponding one of the paired leads 17. With the electrode group 2 and the leads 17 being accommodated in the inner cavity 10, the lid member 6 is attached to the peripheral wall 8 of the exterior container 5 to close the opening of the inner cavity 10 with the lid member 6. Thereafter, a predetermined process including filling of an electrolytic solution into the inner cavity 10 is performed, and thereby the battery 1 is manufactured. Note that the joining of the current collecting bundle 12 to the lead 17 is performed using a joining apparatus.

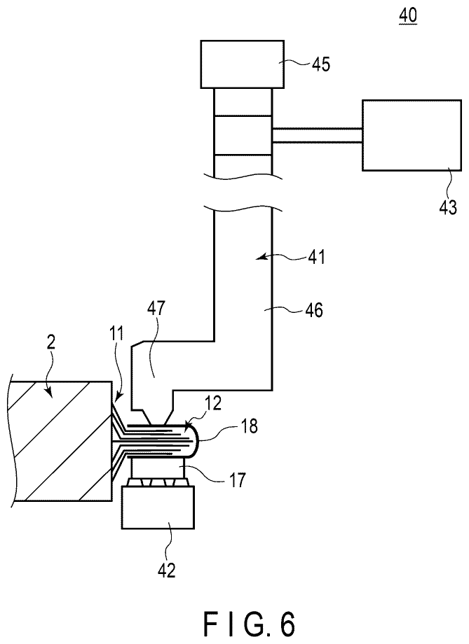

FIG. 6 is a schematic diagram showing an example of a configuration of a joining apparatus 40 used in the manufacturing of the battery 1 according to the first embodiment. In the present embodiment, each of the current collecting bundles 12 of the electrode group 2 is joined to the corresponding one of the leads 17 by using, for example, the joining apparatus 40. As shown in FIG. 6, etc., the joining apparatus 40 includes a joining jig 41, a stage 42 such as an anvil, a pressurizing unit 45, and an ultrasonic transducer 43. In a case of joining a joined target part using the joining apparatus 40, the joined target part is interposed between the joining jig 41 and the stage 42.

The pressurizing unit 45 applies a pressure to the joining jig 41 with the joined target part interposed between the joining jig 41 and the stage 42. Thereby, the joined target part interposed between the joining jig 41 and the stage 42 is pressed by the joining jig 41. Note that in one example, the pressuring unit 45 applies a pressure to the stage 42, instead of the joining jig 41. In this case, the joined target part interposed between the joining jig 41 and the stage 42 is pressed by the stage 42. In another example, the pressuring unit 45 applies a pressure to both the joining jig 41 and the stage 42. In this case, the joined target part interposed between the joining jig 41 and the stage 42 is pressed by both the joining jig 41 and the stage 42.

The ultrasonic transducer 43 generates ultrasonic vibration by being supplied with AC power such as high-frequency power. The ultrasonic transducer 43 transmits the generated ultrasonic vibration to the joined target part through the joining jig 41 with the joined target part interposed between the joining jig 41 and the stage 42. Accordingly, in the joining apparatus 40, the joined target part is joined by ultrasonic welding or the like through application of a pressure to at least one of the joining jig 41 and the stage 42 and through transmission of an ultrasonic vibration to the joined target part, with the joined target part interposed between the joining jig 41 and the stage 42.

The joining jig 41 includes a jig main body 46 and a joining tip portion 47. In the joining jig 41, the jig main body 46 extends from a proximal side to a distal side, and the joining tip portion 47 is connected to a distal end portion of the jig main body 46. In the example of FIG. 6, the joining tip portion 47 bends from the jig main body 46. However, in one example, the joining tip portion 47 may extend straight or substantially straight to the jig main body 46, instead of bending from the jig main body 46.

In the joining of the joined target part, the joining tip portion 47 is brought into contact with the joined target part, and the joined target part is interposed between the joining tip portion 47 and the stage 42. In the configuration in which a pressure is applied from the pressuring unit 45 to the joining jig 41, the joining tip portion 47 presses the joined target part through the application of the pressure from the pressuring unit 45. The vibration generated by the ultrasonic transducer 43 is transmitted to the joined target part through the jig main body 46 and then through the joining tip portion 47.

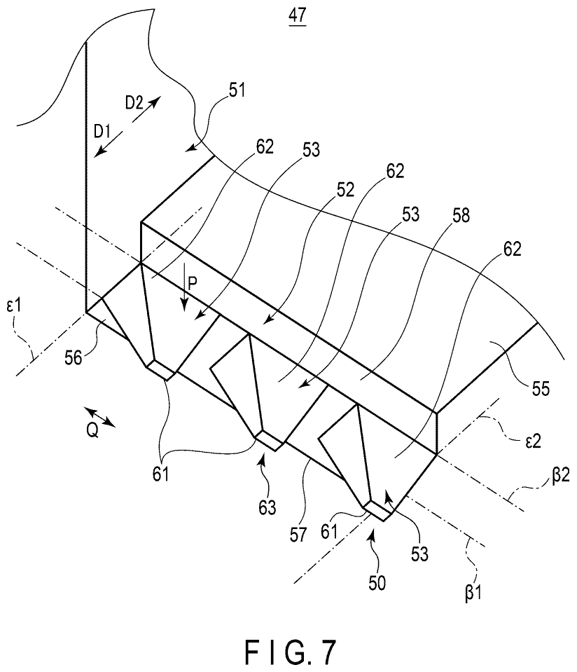

FIG. 7 is a perspective view schematically showing an example of a configuration of the joining tip portion 47 of the joining jig 41 according to the first embodiment. As shown in FIG. 7, etc., the joining tip portion 47 includes a base portion 51, and a protruding stand 52 protruding from the base portion 51. In the joining tip portion 47 of the joining jig 41, a protruding direction of the protruding stand 52 (as indicated by an arrow P) is defined. In the example of FIG. 7, a base surface 55 is formed on the base portion 51, and the protruding stand 52 protrudes from the base surface 55 to the protruding direction. In the joining tip portion 47, a width direction of the protruding stand 52 (as indicated by an arrow Q) crossing (perpendicular to or substantially perpendicular to) the protruding direction of the protruding stand 52, and a depth direction of the protruding stand 52 (as indicated by arrows D1 and D2) crossing (perpendicular to or substantially perpendicular to) both the protruding direction and the width direction are defined.

The protruding stand 52 includes a pedestal portion (pedestal surface) 56 and a pair of stand side portions (stand side surfaces) 57 and 58. The pedestal portion 56 faces the protruding direction, and, in the protruding stand 52, a protruding end (a protruding end face) of the protruding portion that protrudes from the base surface 55 of the base portion 51 is formed by the pedestal portion 56. Each of the stand side portions 57 and 58 extends toward the protruding direction of the protruding stand 52 from the base portion 51 to the pedestal portion 56, and forms a part of an outer peripheral surface of the protruding stand 52. Each of the stand side portions 57 and 58 extends from a root of protrusion of the protruding stand 52 to its protruding end. Note that the root of the protrusion of the protruding stand 52 is defined by the base surface 55 of the base portion 51, and an outer peripheral surface of the protruding stand 52 extends from the base portion 51 to the pedestal portion 56 along the protruding direction of the protruding stand 52.

The stand side portion (first stand side portion) 57 faces one side (the side of the arrow D1) in the depth direction of the protruding stand 52, and an end of the protruding stand 52 on one side in the depth direction is formed by the stand side portion 57. The stand side portion (second stand side portion) 58 faces a side opposite to the side to which the stand side portion 57 faces (faces the side of the arrow D2) in the depth direction of the protruding stand 52, and an end of the protruding stand 52 on the opposite side to the stand side portion 57 in the depth direction is formed by the stand side portion 58.

In the example of FIG. 7, the base surface 55 of the base portion 51 neighbors the protruding stand 52 from a side to which the stand side portion 58 faces in the depth direction of the protruding stand 52. An end of the stand side portion 58 on an opposite side to the protruding direction is connected to the base surface 55 of the base portion 51, and the stand side portion 58 extends in the protruding direction from the base surface 55. Note that, in the example of FIG. 7, the base surface 55 is not formed in a region on the side to which the stand side portion 57 faces in the depth direction, with respect to the protruding stand 52. The base surface 55 is not formed in a region on an outer side of the protruding stand 52 in the width direction, either.

In the present embodiment, a convex structure 50 protruding from the protruding stand 52 is formed in the joining tip portion 47. The convex structure 50 includes and is configured of one or more projections 53. Each of the projections 53 further protrudes from the pedestal portion 56 toward the protruding direction of the protruding stand 52. Accordingly, each projection 53 further protrudes from the protruding end of the protruding stand 52.

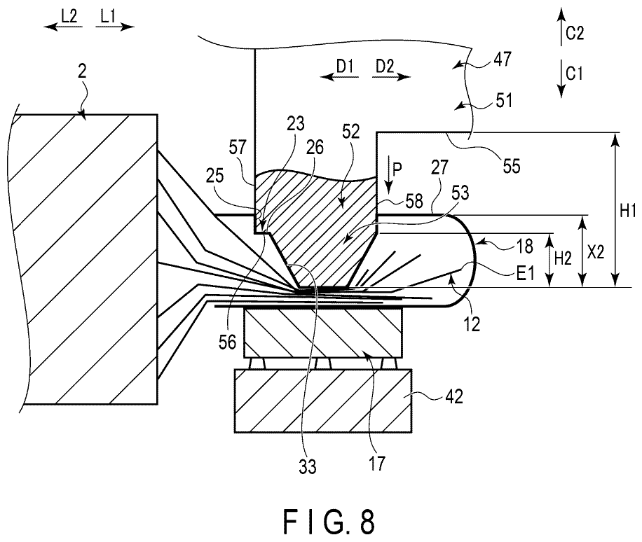

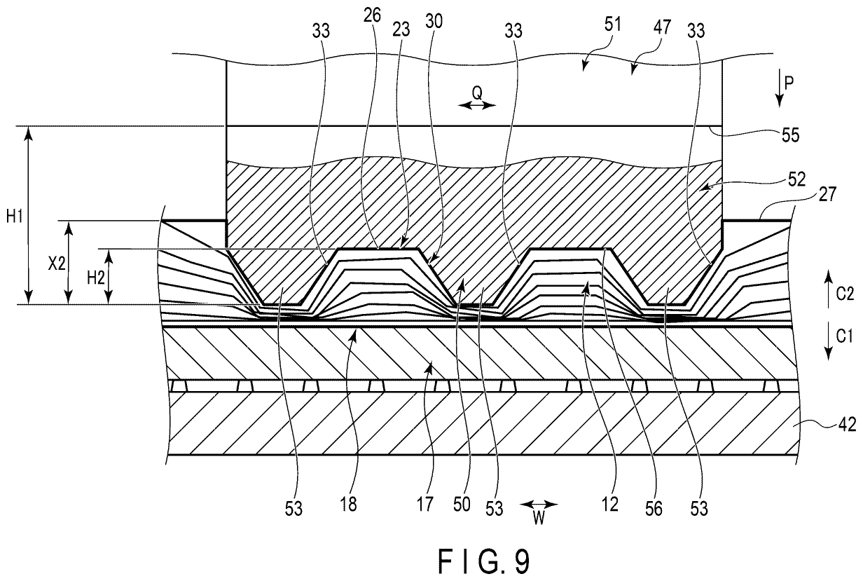

A protrusion length H1 along the protruding direction from the base surface 55 of the base portion 51 to the protruding end of one or more projections 53 of the convex structure 50, and a protrusion length H2 along the protruding direction from the pedestal portion 56 of the protruding stand 52 to the protruding end of the one or more projections 53 are defined (see FIGS. 8 and 9). In the present embodiment with the above-described configuration, the protrusion length H1 is greater than the protrusion length H2. Each of the projections 53 is formed, for example, in a polygonal pyramid shape, a polygonal truncated pyramid shape, a conical shape, a truncated conical shape, and a shape similar to one of these.

Each of the projections 53 includes a pair of projection side portions (projection side surfaces) 61 and 62. Each of the projection side portions 61 and 62 of each of the one or more projections 53 extends from the pedestal portion 56 of the protruding stand 52 toward the protruding direction, and extends to the protruding end of the projection 53. Each of the projection side portions 61 and 62 of each of the one or more projections 53 forms a part of an outer peripheral surface of the projection 53. Note that the outer peripheral surface of each projection 53 extends from the pedestal portion 56 to the protruding end of the projection 53 along the protruding direction of the protruding stand 52.

In each projection 53, the projection side portion (first projection side portion) 61 faces the side to which the stand side portion (first stand side portion) 57 faces (faces the side of the arrow D1) in the depth direction, and the projection side portion (second projection side portion) 62 faces the side to which the stand side portion (second stand side portion) 58 faces (faces the side of the arrow D2) in the depth direction. An end of each projection 53 on one side in the depth direction is formed by the projection side portion 61, and an end of the projection 53 on the opposite side to the projection side portion 61 in the depth direction is formed by the projection side portion 62.

In the example of FIG. 7, the convex structure 50 is configured of a plurality of (e.g., three) projections 53. The plurality of projections 53 are aligned along the width direction of the protruding stand 52, and form a single projection string 63. In the convex structure 50 (projection string 63) of the example of FIG. 7, the plurality of projections 53 are not displaced or not substantially displaced from each other in the depth direction of the protruding stand 52. Thus, the plurality of projections 53 that form the projection string 63 have equal or substantially equal separation distances from the stand side portion 57 along the depth direction of the protruding stand 52. The plurality of projections 53 that form the projection string 63 have equal or substantially equal separation distances from the stand side portion 58 along the depth direction of the protruding stand 52.

In the example of FIG. 7, only a single projection string 63 is formed in the convex structure 50. Thus, the plurality of projections 53 that form the convex structure 50 have equal or substantially equal separation distances from the stand side portion 57 along the depth direction of the protruding stand 52. The plurality of projections 53 that form the convex structure 50 have equal or substantially equal separation distances from the stand side portion 58 along the depth direction of the protruding pedestal 52.

In the present embodiment, the pedestal portion 56 of the protruding stand 52 neighbors the convex structure 50 from the side to which the stand side portion (first stand side portion) 57 faces in the depth direction of the protruding stand 52. Thus, the pedestal portion 56 sticks out, beyond the convex structure 50, to the side to which the stand side portion 57 faces. In the example of FIG. 7, the pedestal portion 56 neighbors the projection string 63 from the side to which the stand side portion 57 faces, and neighbors each of the projections 53 configuring the projection string 63 from the side to which the stand side portion 57 faces. Accordingly, in the present embodiment, the pedestal portion 56 extends to a region on the side to which the stand side portion 57 faces in the depth direction of the protruding stand 52, with respect to an end of the convex structure 50 on the side to which the stand side portion 57 faces. In the convex structure 50, a position through which an imaginary line β1 (see FIG. 7) passes, for example, forms an end on the side to which of the stand side portion 57 faces.

In the preferable example as shown in FIG. 7, the pedestal portion 56 does not stick out, beyond the convex structure 50, to the side to which the stand side portion (the second stand side portion) 58 faces. That is, the pedestal portion 56 does not stick out, beyond an end of the convex structure 50 on the side to which the stand side portion 58 faces, to the side to which the stand side portion 58 faces in the depth direction of the protruding stand 52. In the convex structure 50, a position through which an imaginary line β2 (see FIG. 7) passes, for example, forms an end on the side to which the stand side portion 58 faces. In the example of FIG. 7, the pedestal portion 56 does not stick out, beyond the projection string 63, to the side to which the stand side portion 58 faces, and does not stick out, beyond each of the projections 53 configuring the projection string 63, to the side to which the stand side portion 58 faces. The projection side portion 62 of each of the projections 53 is connected to the stand side portion 58 of the protruding stand 52 without the pedestal portion 56 being intervened therebetween.

In the preferable example as shown in FIG. 7, the pedestal portion 56 does not stick out, beyond the convex structure 50, in the width direction of the protruding stand 52. Thus, the pedestal portion 56 is not formed in a region on an outer side of the convex structure 50 in the width direction of the protruding stand 52. In the convex structure 50, for example, a position through which an imaginary line ε1 (see FIG. 7) passes forms one end in the width direction of the protruding stand 52, and a position through which an imaginary line ε2 (see FIG. 7) passes forms the other end in the width direction of the protruding stand 52. In a preferable example, the pedestal portion 56 does not stick out to an outer side of the imaginary lines ε1 and ε2 in the width direction of the protruding stand 52. In the example shown in FIG. 7, the pedestal portion 56 does not stick out to either side of the projection string 63 in the width direction. That is, the pedestal portion 56 does not stick out to an outer side with respect to each of the projections 53 located at both ends in the width direction of the protruding stand 52, among the projections 53 configuring the projection string 63.

As described above, in the preferable example as shown in FIG. 7, in a configuration in which the pedestal portion 56 neighbors the convex structure 50 from the side to which the stand side portion (first stand side portion) 57 faces in the depth direction of the protruding stand 52, the pedestal portion 56 sticks out beyond the convex structure 50 only to the side to which the stand side portion 57 faces. The pedestal portion 56 does not stick out, beyond the convex structure 50, to the side to which the stand side portion (second stand side portion) 58 faces, and to either side in the width direction of the protruding stand 52.

In the example of FIG. 7, each of the plurality of projections 53 of the projection string 63 is spaced apart from a neighboring projection 53. In the joining tip portion 47, the pedestal portion 56 extends between the projections 53 neighboring each other in the width direction of the protruding stand 52 in the projection string 63. Thus, in the example of FIG. 7, the plurality of projections 53 configuring the convex structure 50 include two or more projections 53 distanced from each other in the width direction of the protruding stand 52. The pedestal portion 56 extends between the two or more projections 53 spaced apart in the width direction. In the example of FIG. 7, in the part in which the projection string 63 is formed, the pedestal portions 56 and the projections 53 are alternately disposed along the width direction of the protruding stand 52 (the arrangement direction in the projection string 63).

In the joining tip portion 47 of the example shown in FIG. 7, the base surface 55 of the base portion 51 is located on the side to which the stand side portion 58 faces in the depth direction of the protruding stand 52, with respect to the convex structure 50. Accordingly, the base surface 55 is located on the side to which the stand side portion 58 faces, with respect to each of the projections 53 configuring the convex structure 50. In the example of FIG. 7, the base surface 55 is not formed in a region on the side to which the stand side portion 57 faces in the depth direction, with respect to the convex structure 50. The base surface 55 is not formed in a region on an outer side of the convex structure 50 in the width direction, either.

In the joining of the current collecting bundle 12 to the lead 17, the joined target part, in which the current collecting bundle 12 and the lead 17 are stacked, is interposed between the joining tip portion 47 of the joining jig 41 and the stage 42. At this time, as shown in FIG. 6, etc., the joining tip portion 47 is brought into contact with the joined target part from the side opposite to the stacking side of the lead 17 in the thickness direction of the electrode group 2. The stage 42 is brought into contact with the joined target part from the stacking side of the lead 17 in the thickness direction of the electrode group 2.

The pressuring unit 45 applies a pressure to at least one of the joining jig 41 and the stage 42, causing at least one of the joining jig 41 and the stage 42 to press the joined target part, with the joined target part interposed between the joining jig 41 and the stage 42. Furthermore, ultrasonic vibration is transmitted to the joined target part through the joining jig 41, with the joined target part interposed between the joining jig 41 and the stage 42. Thereby, joining of the joined target part is performed, and a joint part in which the current collecting bundle 12 and the lead 17 are joined is formed.

FIG. 8 is a schematic view showing an example of a state in which one of the current collecting bundles 12 of the electrode group 2 is joined to the lead 17 in the first embodiment, in a cross section perpendicular to or substantially perpendicular to the width direction of the electrode group 2. FIG. 9 is a schematic diagram showing the state of FIG. 8 in a cross section perpendicular to or substantially perpendicular to the length direction of the electrode group 2 (the protruding direction of the current collecting bundle 12). FIG. 8 shows a part of the joining tip portion 47 in a cross section perpendicular to or substantially perpendicular to the width direction of the protruding stand 52, and shows the other part as viewed from one side in the width direction of the protruding stand 52. FIG. 9 illustrates a part of the joining tip portion 47 in a cross section perpendicular to or substantially perpendicular to the depth direction of the protruding stand 52, and shows the other part as viewed from one side in the depth direction of the protruding stand 52.

Hereinafter, joining of one of the current collecting bundles 12 to the lead 17 will be described. In manufacturing of the battery 1, in each of the positive-electrode uncoated part and the negative-electrode uncoated part, joining of the current collecting bundle 12 to the lead 17 is performed in a similar manner to aspects or the like to be described below.

As shown in FIGS. 8 and 9, etc., in joining of the current collecting bundle 12 to the lead 17, the joining tip portion 47 is brought into contact with the joined target part with the protruding stand 52 and one or more projections 53 of the convex structure 50 protruding toward the joined target part. Thus, in the state in which the joining of the joined target part is being performed, the protruding direction of the protruding stand 52 extends along the thickness direction of the electrode group 2, and the protruding stand 52 protrudes from the base portion 51 toward the side on which the lead 17 is located (toward the side of the arrow C1). In the joining of the current collecting bundle 12 to the lead 17, the joining tip portion 47 is brought into contact with the joined target part, with the width direction of the protruding stand 52 (as indicated by an arrow Q) extending along the width direction of the electrode group (as indicated by an arrow W), and the depth direction of the protruding stand 52 (as indicated by arrows D1 and D2) extending along the length direction of the electrode group (as indicated by arrows L1 and L2). The joining tip portion 47 is brought into contact with the joined target part, with the stand side portion (first stand side portion) 57 of the protruding stand 52 facing the side opposite to the protruding side of the current collecting bundle 12 (facing the side of the arrow L2).

In the joining of the current collecting bundle 12 to the lead 17, by applying a pressure to at least one of the joining jig 41 and the stage 42, the pedestal portion 56 and one or more projections 53 of the convex structure 50 of the joining tip portion 47 are brought into contact with the joined target part. The joined target part is joined by ultrasonic welding by transmitting ultrasonic vibration to the joined target part through the joining tip portion 47, with the pedestal portion 56 and one or more projections 53 of the joining tip portion 47 being brought into contact with the joined target part. By joining the current collecting bundle 12 to the lead 17 as described above, in the joint part between the lead 17 and the current collecting bundle 12, the groove bottom 26 of the groove 23 is formed in the part with which the pedestal portion 56 is brought into contact, and a concave portion 33 is formed in each of the parts with which the one or more projections 53 of the convex structure 50 are brought into contact. A concave structure 30 is formed of one or more concave portions 33.

In the present embodiment, in the joining jig 41 used for joining, the pedestal portion 56 neighbors the convex structure 50 from the side to which the stand side portion 57 faces in the depth direction of the protruding stand 52. Thus, in the joint part between the current collecting bundle 12 and the lead 17, the groove bottom 26 of the groove 23 neighbors the concave structure 30 from the side opposite to the protruding side of the current collecting bundle 12 in the length direction of the electrode group 2.

Also, in the joining of the joined target part, the pedestal portion 56 and one or more projections 53 of the convex structure 50 are brought into contact with the joined target part, but the base portion 51 including the base surface 55 is not brought into contact with the joined target part. Thus, a depression amount X2 from the reference surface 27 of each of the concave portions 33 is smaller than a protrusion length H1 from the base surface 55 of the base portion 51 to a protruding end of the one or more projections 53 of the convex structure 50 along the protruding direction. The depression amount X2 from the reference surface 27 of each of the concave portions 33 is greater than a protrusion length H2 from the pedestal portion 56 of the protruding stand 52 to the protruding end of one or more projections 53 along the protruding direction.

In a preferable example of the present embodiment, the pedestal portion 56 and one or more projections 53 are brought into contact with the joined target part, with the pedestal portion 56 not sticking out, beyond the lead 17, to the protruding side of the current collecting bundle 12 in the length direction of the electrode group 2, or to the opposite side to the protruding side of the current collecting bundle 12 in the length direction of the electrode group 2. Thus, in the preferable example, the joint part in which the lead 17 and the current collecting bundle 12 are joined is configured in such a manner that the groove 23 does not stick out either to the protruding side of the current collecting bundle 12 or to the opposite side to the protruding side of the current collecting bundle 12, similarly to the example as shown in FIGS. 3-5.

In a preferable example according to the present embodiment, the joining jig 41 used for joining of the joined target part is configured in such a manner that the pedestal portion 56 does not stick out, beyond the convex structure 50, to the side to which the stand side portion (second stand side portion) 58 faces, similarly to the joining jig 41 in the example as shown in FIG. 7. Thus, in the preferable example, the joint part between the current collecting bundle 12 and the lead 17 is configured in such a manner that the groove 23 does not stick out, beyond the concave structure 30, to the protruding side of the current collecting bundle 12 in the length direction of the electrode group 2, similarly to the example as shown in FIGS. 3-5.

In a preferable example of the present embodiment, the joining jig 41 used for joining of the joined target part is configured in such a manner that the pedestal portion 56 does not stick out, beyond the convex structure 50, to either side in the width direction of the protruding stand 52, similarly to the joining jig 41 in the example as shown in FIG. 7. Thus, in the preferable example, the joint part between the current collecting bundle 12 and the lead 17 is configured in such a manner that the groove 23 does not stick out, beyond the concave structure 30, to either side in the width direction of the electrode group 2, similarly to the example as shown in FIGS. 3-5.

In an example of the present embodiment, the joining jig 41 used for joining of the joined target part is configured in such a manner that the pedestal portion 56 extends between two or more projections 53 distanced from each other in the width direction of the protruding stand 52. Thus, in the present example, the joint part between the current collecting bundle 12 and the lead 17 is configured in such a manner that the groove bottom 26 of the groove 23 extends between two or more concave portions 33 distanced from each other in the width direction of the electrode group 2, similarly to the example as shown in FIGS. 3-5.

As described above, in the present embodiment, joining of the joined target part is performed using a joining jig 41 in which the pedestal portion 56 forms a protruding end of the protruding stand 52 that protrudes from the base portion 51, and one or more projections 53 of the convex structure 50 further protrude from the pedestal portion 56 toward the protruding direction of the protruding stand 52. In the joining of the joined target part, the pedestal portion 56 and one or more projections 53 of the joining jig 41 are brought into contact with the joined target part, from the side opposite to the stacking side of the lead 17 in the thickness direction of the electrode group 2. The current collecting bundle 12 is joined to the lead 17, with the pedestal portion 56, as well as the one or more projections 53, brought into contact with the joined target part, thus improving the bonding strength at the joint part.

In the present embodiment, joining is performed using the joining jig 41 in which the pedestal portion 56 neighbors the convex structure 50 from the side to which the stand side portion (first stand side portion) 57 faces in the depth direction of the protruding stand 52. In the joining of the joined target part, the pedestal portion 56 and one or more projections 53 of the convex structure 50 are brought into contact with the joined target part, with the stand side portion 57 facing the side opposite to the protruding side of the current collecting bundle 12 in the length direction of the electrode group 2. Thus, in a region that neighbors a portion with which the convex structure 50 is brought into contact on the side opposite to the protruding side of the current collecting bundle 12, the joined target part is pressed by the pedestal portion 56 toward the side on which the lead 17 is located in the thickness direction of the electrode group 2. Thereby, in the joint part between the lead 17 and the current collecting bundle 12, etc., in a region that neighbors the concave structure 30 on the side opposite to the protruding side of the current collecting bundle 12, it is possible to suitably suppress warping of the current collecting bundle 12, the clip 18, etc. toward the side opposite to the side on which the lead is located in the thickness direction. Accordingly, it is possible to ensure suitable joining between the lead 17 and the current collecting bundle 12, etc. at the region that neighbors the concave structure 30 on the side opposite to the protruding side of the current collecting bundle 12.

By ensuring suitable joining at the region that neighbors the concave structure 30 on the side opposite to the protruding side of the current collecting bundle 12, the current collecting bundle 12 is suitably connected to a corresponding one of the terminals 15 via the lead 17, etc. to be joined. It is thereby possible to ensure suitable electrical connection of the current collecting bundle 12 with a corresponding one of the terminals 15.

In a preferable example of the present embodiment, the pedestal portion 56 and one or more projections 53 of the convex structure 50 are brought into contact with the joined target part with the pedestal portion 56 not sticking out, beyond the lead 17, to the protruding side of the current collecting bundle 12 in the length direction of the electrode group 2. Thereby, the joining is performed in such a manner that the region at which the pedestal portion 56 is brought into contact with the joined target part is distanced by a certain length toward the inside in the length direction of the electrode group 2, with respect to the protruding end E1 of the current collecting bundle 12. Since the pedestal portion 56 is brought into contact with the joined target part, as described above, it is possible to effectively prevent the joint part from excessively expanding, due to the joining, to the protruding side of the current collecting bundle 12. In other words, it is possible to suitably suppress improper deformation of the joint part including the current collecting bundle 12 due to the joining. Accordingly, the current collecting bundle 12 of the electrode group 2 can be joined to the lead 17 by suppressing inappropriate deformation of the joint part due to the joining, while ensuring joining at the region that neighbors the concave structure 30 on the side opposite to the protruding side of the current collecting bundle 12.

By suppressing excessive expansion of the joint part to the protruding side of the current collecting bundle 12, it is possible, for example, to prevent interference of the joint part between the current collecting bundle 12, the lead 17, and the like with the exterior container 5 in accommodating the electrode group 2, the lead 17, etc., into the inner cavity 10 of the exterior container 5. This facilitates insertion of an assembly in which the electrode group 2, the lead 17, and the like, are assembled, in accommodating the electrode group 2, the lead 17, and the like, into the inner cavity 10 of the exterior container 5. Accordingly, in the manufacturing of the battery 1, the work efficiency in the work of accommodating the electrode group 2 and the lead 17 into the inner cavity 10 is improved.

In a preferable example of the present embodiment, the pedestal portion 56 and one or more projections 53 of the convex structure 50 are brought into contact with the joined target part, with the pedestal portion 56 not sticking out, beyond the lead 17, to the side opposite to the protruding side of the current collecting bundle 12 in the length direction of the electrode group 2, either. It is thereby possible to more suitably suppress improper deformation of the joint part due to the joining. By thus performing the joining, the bonding strength at the region that neighbors the concave structure 30 on the side opposite to the protruding side of the current collecting bundle 12 is further improved.

In a preferable example of the present embodiment, a joining jig 41, etc. including a pedestal portion 56 that does not stick out, beyond the convex structure 50, to the side to which of the stand side portion (second stand side portion) 58 faces, is used for joining, and a groove portion 23 is formed in the joint part so as not to stick out, beyond the concave structure 30, to the protruding side of the current collecting bundle 12. It is thereby possible to more effectively prevent the joint part from excessively expanding, due to the joining, to the protruding side of the current collecting bundle 12. Accordingly, it is possible to further suitably suppress improper deformation of the joint part due to the joining.

In a preferable example of the present embodiment, a joining jig 41, etc. including a pedestal portion 56 that does not stick out, beyond the convex structure 50, in the width direction of the protruding stand 52 is used for joining, and a groove 23 is formed in the joint part in such a manner that the groove 23 does not stick out, beyond the concave structure 30, to the width direction of the electrode group 2. It is thereby possible to more suitably suppress improper deformation of the joint part due to the joining. Since the pedestal portion 56 does not stick out, beyond the convex structure 50, to the width direction of the protruding stand 52, a region that neighbors the convex structure 50 from the side to which the stand side portion 57 faces in the pedestal portion 56 can be easily brought into contact with the joined target part. It is thereby possible, in the joint part between the lead 17 and the current collecting bundle 12, etc., to further suitably suppress warping of the current collecting bundle 12, the clip 18, etc. at the region that neighbors the concave structure 30 on the side opposite to the protruding side of the current collecting bundle 12.

In an example of the present embodiment, a joining jig 41 including a pedestal portion 56 that extends between two or more projections 53 distanced from each other in the width direction of the protruding stand 52 is used for joining. This allows the groove bottom 26 of the groove portion 23 to extend between two or more concave portions 33 distanced from each other in the width direction of the electrode group 2 in the joint part. By performing joining with the pedestal portion 56 brought into contact with the joined target part between the concave portions 33 distanced from each other, the bonding strength at the joint part is further improved.

### (Modifications)

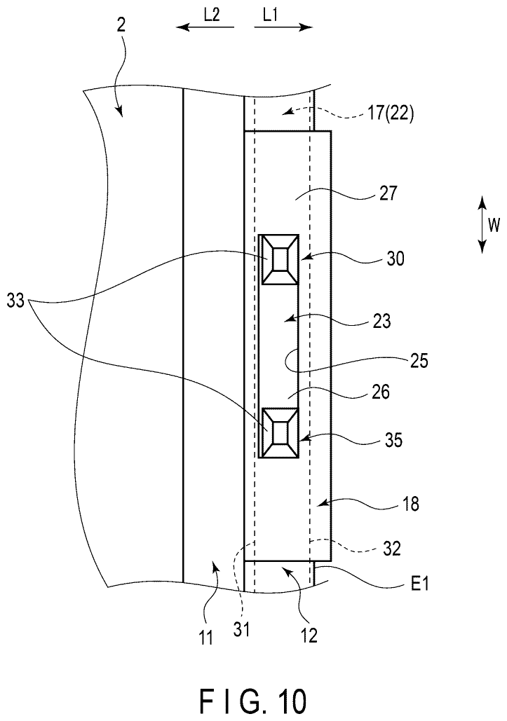

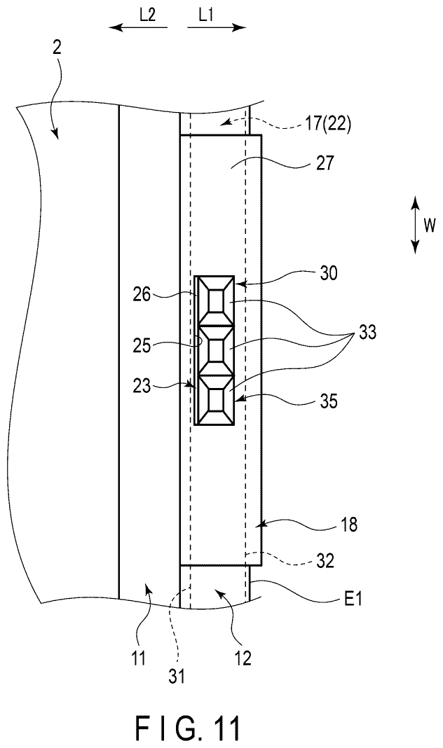

FIG. 10 is a schematic diagram showing an example of a configuration of a joint part (connection part) in which a single current collecting bundle 12 of an electrode group 2 is joined to a lead 17, and a vicinity thereof, in a battery 1 according to a first modification. FIG. 11 is a schematic diagram showing an example of a configuration of a joint part (connection part) in which a single current collecting bundle 12 of an electrode group 2 is joined to a lead 17, and a vicinity thereof, in a battery 2 according to a second modification. In the first modification shown in FIG. 10 and the second modification shown in FIG. 11, too, a groove 23 and one or more concave portions 33 of a concave structure 30 are formed in the joint part between the current collecting bundle 12 and the lead 17. The groove bottom 26 of the groove 23 neighbors the concave structure 30 from a side opposite to a protruding side of the current collecting bundle 12 in a length direction of the electrode group 2. FIGS. 10 and 11 show a state as viewed from one side in a thickness direction of the electrode group 2 (a depth direction of the battery 1 and a stacking direction of a plurality of current collecting strips 13), showing a state as viewed from a side opposite to a stacking side of the lead 17 (leg plate 22) in the thickness direction of the electrode group 2.

In a preferable example according to the first and second modifications, similarly to the example as shown in FIG. 10 and the example as shown in FIG. 11, the groove 23 does not stick out, beyond the lead 17, to the protruding side of the current collecting bundle 12 in the length direction of the electrode group 2, or to a side opposite to the protruding side of the current collecting bundle 12 in the length direction of the electrode group 2. In the example shown in FIG. 10 and the example shown in FIG. 11, similarly to the first embodiment, etc., a concave structure 30 is configured of a plurality of concave portions 33, and a concave portion string 35 including a plurality of concave portions 33 that are aligned along the width direction of the electrode group 2 is formed in the concave structure 30. In the concave structure 30 (concave portion string 35), the plurality of concave portions 33 are not displaced or not substantially displaced from each other in the length direction of the electrode group 2.

In a preferable example according to the first and second modifications, similarly to the example as shown in FIG. 10 and the example as shown in FIG. 11, the groove 23 (groove bottom 26) does not stick out, beyond any of the concave portions 33 forming the concave structure 30 (concave portion string 35), to the protruding side of the current collecting bundle 12 (the outer side in the length direction of the electrode group 2), and does not stick out, beyond the concave structure 30, to the protruding side of the current collecting bundle 12. In a preferable example, the groove 23 (groove bottom 26) does not stick out, beyond the concave structure 30, to either side in the width direction of the electrode group 2.

Accordingly, in a preferable example according to the first and second modifications, too, in a configuration in which the groove bottom 26 of the groove 23 neighbors the concave structure 30 from the side opposite to the protruding side of the current collecting bundle 12 in the length direction, the groove 23 (groove bottom 26) sticks out, beyond the concave structure 30, only to the side opposite to the protruding side of the current collecting bundle 12. The groove portion 23 does not stick out, beyond the concave structure 30, to the protruding side of the current collecting bundle 12, or to either side in the width direction.

As shown in FIG. 10, etc., in the first modification, the concave portion string 35 is configured only of two concave portions 33, and the concave structure 30 is configured only of the two concave portions 33. However, in the first modification, too, the groove bottom 26 of the groove 23 extends between concave portions 33 neighboring each other in the width direction of the electrode group 2 in the concave portion string 35. Thus, the groove bottom 26 of the groove 23 extends between two concave portions 33 distanced from each other in the width direction. In the first modification, too, the groove bottom 26 neighbors the concave portion string 35 from a side opposite to the protruding side of the current collecting bundle 12.

As shown in FIG. 11, etc., in the second modification, the concave portion string 35 is configured in such a manner that a plurality of concave portions 33 are continuously provided in the width direction of the electrode group 2. Thus, in the concave portion string 35, the groove bottom 26 is not formed between the concave portions 33 neighboring each other in the width direction of the electrode group 2. In the present modification, similarly to the first embodiment, the first modification, etc., the groove bottom 26 neighbors the concave portion string 35 from a side opposite to the protruding side of the current collecting bundle 12.

In the first and second modifications, too, joining of the lead 17 to the current collecting bundle 12 is performed using a joining jig 41 in which a pedestal portion 56 forms a protruding end of a protruding stand 52 that protrudes from a base portion 51, and one or more projections 53 of a convex structure 50 further protrude from the pedestal portion 56 toward a protruding direction of the protruding stand 52. In the joining jig 41 used for joining, the pedestal portion 56 neighbors the convex structure 50 (projection string 63) from the side to which the stand side portion (first stand side portion) 57 in the depth direction of the protruding stand 52. The joining is performed in a similar manner to the first embodiment, etc., and in the joint part between the lead 17 and the current collecting bundle 12, the groove bottom 26 of the groove 23 is formed in a part with which the pedestal portion 56 is brought into contact, and a concave portion 33 is formed in each of the parts with which the one or more projections 53 of the convex structure 50 are brought into contact.

In a preferable example according to the first and second modifications, too, the joining is performed in such a manner that the pedestal portion 56 and one or more projections 53 are brought into contact with the joined target part, with the pedestal portion 56 not sticking out, beyond the lead 17, to the protruding side of the current collecting bundle 12 in the length direction of the electrode group 2 or the side opposite to the protruding side of the current collecting bundle 12 in the length direction of the electrode group 2, either. In the joining jig 41 used in the example shown in FIG. 10 and the example shown in FIG. 11, similarly to the first embodiment, etc., a projection string 63 configured of a plurality of projections 53 that are aligned along the width direction of the protruding stand 52 is formed in the convex structure 50. In the convex structure 50 (projection string 63), the plurality of projections 53 are not displaced or not substantially displaced from each other in the depth direction of the protruding stand 52.

In a preferable example of the joining jig 41 according to the first and second modifications, the pedestal portion 56 does not stick out, beyond each of the projections 53 forming the convex structure 50 (projection string 63), to the side to which the stand side portion (second stand side portion) 58 faces, and does not stick out, toward the side to which the stand side portion 58 faces, beyond the convex structure 50. In a preferable example, the pedestal portion 56 does not stick out, beyond the convex structure 50, to either side in the width direction of the protruding stand 52.

Accordingly, in a preferable example according to the first and second modifications, the pedestal portion 56, which is configured to neighbor the convex structure 50 from the side to which the stand side portion (first stand side portion) 57 faces in the depth direction of the protruding stand 52, sticks out beyond the convex structure 50 only to the side to which the stand side portion 57 faces. The pedestal portion 56 does not stick out, beyond the convex structure 50, to the side to which the stand side portion 58 faces, or to either side in the width direction of the protruding stand 52.

In a modification, in the joint part between the current collecting bundle 12 and the lead 17, the concave structure 30 is configured only of a single concave portion 33. In the present modification, too, the groove bottom 26 of the groove 23 neighbors the concave structure 30 from the side opposite to the protruding side of the current collecting bundle 12 in the length direction of the electrode group 2, and in the present modification, the groove bottom 26 neighbors a single concave portion 33 configuring the concave structure 30 from the side opposite to the protruding side of the current collecting bundle 12.

In a preferable example according to the present modification, too, the groove 23 does not stick out, beyond the lead 17, to the protruding side of the current collecting bundle 12 in the length direction of the electrode group 2, or to a side opposite to the protruding side of the current collecting bundle 12 in the length direction of the electrode group 2. In a preferable example according to the present modification, the groove 23 (the groove bottom 26) does not stick out, beyond the concave structure 30, to the protruding side of the current collecting bundle 12 (to an outer side in the length direction of the electrode group 2). Thus, in the preferable example, the groove 23 does not stick out, beyond a single concave portion 33 forming the concave structure 30, to the protruding side of the current collecting bundle 12. In a preferable example, the groove 23 does not stick out, beyond the concave structure 30 (single concave portion 33), to either side in the width direction of the electrode group 2.

In the present modification, joining of the current collecting bundle 12 to the lead 17 is performed similarly to the above-described embodiment, etc., except that the convex structure 50 is configured of a single projection 53, and that a joining jig 41 in which only a single projection 53 protrudes from the pedestal portion 56 is used. In the joint part between the lead 17 and the current collecting bundle 12, the groove bottom 26 of the groove 23 is formed in the part with which the pedestal portion 56 is brought into contact, and a concave portion 33 is formed in a part with which the projection 53 is brought into contact. In the present modification, too, in the joining jig 41 used for joining, the pedestal portion 56 neighbors the convex structure 50 (single projection 53) from the side to which the stand side portion (first stand side portion) 57 faces in the depth direction of the protruding stand 52.

In a preferable example according to the present modification, too, the joining is performed in such a manner that the pedestal portion 56 and the projection 53 of the convex structure 50 are brought into contact with the joined target part, with the pedestal portion 56 not sticking out, beyond the lead 17, to the protruding side of the current collecting bundle 12 in the length direction of the electrode group 2, or to the side opposite to the protruding side of the current collecting bundle 12 in the length direction of the electrode group 2. In a preferable example of the joining jig 41 according to the present modification, too, the pedestal portion 56 does not stick out, beyond the convex structure 50, to the side to which the stand side portion (second stand side portion) 58 faces. Thus, in the joining jig 41 according to the preferable example, the pedestal portion 56 does not stick out, beyond the single projection 53 forming the convex structure 50, to the side to which the stand side portion 58 faces. In a preferable example, the pedestal portion 56 does not stick out, beyond the convex structure 50 (single projection 53), to either side in the width direction of the protruding stand 52.

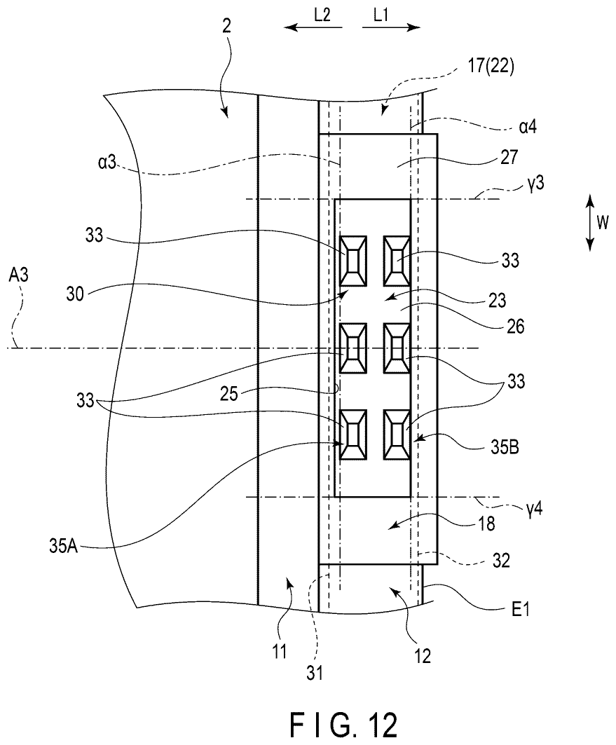

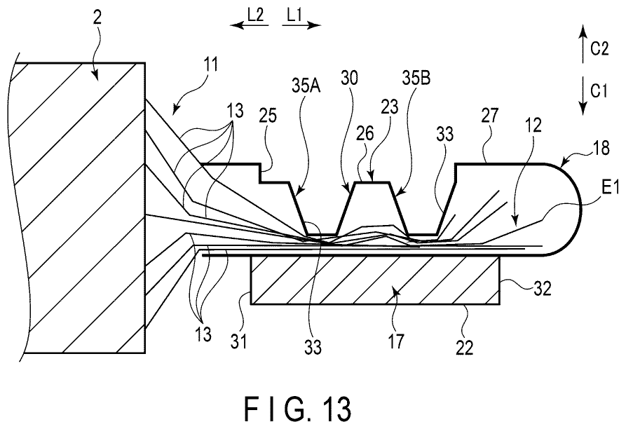

FIG. 12 is a schematic diagram showing an example of a configuration of a joint part (a connection part) in which a single current collecting bundle 12 of the electrode group 2 is joined to a lead 17, and a vicinity thereof, in the battery 1 according to the third modification, as viewed from one side in the thickness direction of the electrode group 2. FIG. 12 shows the battery 1 as viewed from one side in the depth direction of the battery 1 (the stacking direction of the current collecting strips 13), showing a state as viewed from a side opposite to a stacking side of the lead 17 (leg plate 22) in the thickness direction of the electrode group 2. FIG. 13 is a cross-sectional view schematically showing a cross section along an imaginary line A3 in FIG. 12. FIG. 13 shows a configuration of a joint part in which a single current collecting bundle 12 is joined to the lead 17, and the vicinity thereof, in a cross section perpendicular to or substantially perpendicular to the width direction of the electrode group 2 (to the height direction of the battery 1).

In the third modification shown in FIGS. 12 and 13, too, a groove 23 and one or more concave portions 33 of a concave structure 30 are formed in a joint part between a current collecting bundle 12 and a lead 17. The groove bottom 26 of the groove 23 neighbors the concave structure 30 from a side opposite to the protruding side of the current collecting bundle 12 in the length direction of the electrode group 2. In a preferable example according to the third modification, similarly to the example as shown in FIG. 12 and FIG. 13, the groove 23 does not protrude, beyond the lead 17, to the protruding side of the current collecting bundle 12 in the length direction of the electrode group 2, or to a side opposite to the protruding side of the current collecting bundle 12 in the length direction of the electrode group 2.

In the example shown in FIGS. 12 and 13, similarly to the first embodiment, etc., the concave structure 30 is constituted by a plurality of concave portions, and concave portion strings 35A and 35B each including a plurality of concave portions 33 that are aligned along the width direction of the electrode group 2 are formed in the concave structure 30. However, in the present modification, a plurality of concave portion strings 35A and 35B are formed so as to be displaced from each other in the length direction of the electrode group 2. With the above-described configuration, in the present modification as shown for example in FIGS. 12 and 13, one or more concave portions 33 of the plurality of concave portions 33 are displaced from any one of the other concave portions 33 in the length direction of the electrode group 2. Accordingly, one or more concave portions 33 of the plurality of concave portions 33 have different separation distances from the protruding end E1 of the current collecting bundle 12 relative to any one of the other concave portions 33 along the length direction of the electrode group 2.

Of the plurality of concave portions 33, a concave portion 33M (remotest concave portion) most distanced from the protruding end E1 of the current collecting bundle 12, and a concave portion (closest concave portion) 33N closest to the protruding end E1 of the current collecting bundle 12 are defined. In the configuration in which one or more concave portions 33 of the plurality of concave portions 33 are displaced from any one of the other concave portions 33 in the length direction of the electrode group 2, as in the present modification, the number of each of the concave portions 33M and 33N in the plurality of concave portions 33 is more than one. Depending on the arrangement of the plurality of concave portions 33 configuring the concave structure 30, the number of at least one of the concave portions 33M and 33N may be more than one. In the example shown in FIGS. 12 and 13, three concave portions 22 forming the concave portion string 35A in the concave structure 30 function as the concave portion (remotest concave portion) 33M, and three concave portions forming the concave portion string 35B function as the concave portion (closest concave portion) 33N. Note that the concave portion (remotest concave portion) 33M is also referred to as a “first concave portion”, and the concave portion (closest concave portion) 33N is also referred to as a “second concave portion”.

In the present modification, the groove bottom 26 of the groove 23, which neighbors the concave structure 30 from a side opposite to the protruding side of the current collecting bundle 12 in the length direction, neighbors one or more concave portion 33 that function as the concave portion (remotest concave portion) 33M from a side opposite to the protruding side of the current collecting bundle 12. The groove 23 sticks out, beyond the one or more concave portions 33 that function as the concave portion 33M, to a side opposite to (an inner side of) the protruding side of the current collecting bundle 12. In the example of FIGS. 12 and 13, the groove bottom 26 of the groove 23 neighbors each of the three concave portions forming the concave portion string 35A from a side opposite to the protruding side of the current collecting bundle 12.

Accordingly, in the present modification, too, the groove bottom 26 extends to a region on an inner side in the length direction of the electrode group 2 (on a side opposite to the protruding side of the current collecting bundle 12), with respect to an end of the concave structure 30 on the side opposite to the protruding side of the current collecting bundle 12. In the concave structure 30, a position through which an imaginary line α3 (see FIG. 12) passes, for example, forms the end on the side opposite to the protruding side of the current collecting bundle 12. In the preferable example as shown in FIGS. 12-13, the groove 23 does not stick out, beyond the lead 17, to the side opposite to the protruding side of the current collecting bundle 12 in the length direction of the electrode group 2, as described above. Accordingly, in the preferable example, the groove bottom 26 extends between the plate edge 31 of the lead 17 and the end of the concave structure 30 through which the imaginary line α3 passes.

In a preferable example according to the present modification, the groove 23 does not stick out, beyond the concave structure 30, to the protruding side of the current collecting bundle 12, and the groove 23 does not stick out, beyond one or more concave portions 33 that function as a concave portion (closest concave portion) 33N, to the protruding side of the current collecting bundle 12 (outer side in the length direction of the electrode group 2). In the example of FIGS. 12 and 13, the groove portion 23 does not stick out, beyond any of the three concave portions 33 forming the concave portion string 35B, to the protruding side of the current collecting bundle 12. In the concave structure 30 according to the present modification, a position through which an imaginary line α4 (see FIG. 12) passes, for example, forms an end on the protruding side of the current collecting bundle 12.

In the preferable example as shown in FIGS. 12-13 according to the present modification, too, the groove 23 (the groove bottom 26) does not stick out, beyond the concave structure 30, in the width direction of the electrode group 2. Thus, the groove 23 is not formed in a region on an outer side of the concave structure 30 in the width direction of the electrode group 2. In the concave structure 30 according to the present modification, a position through which an imaginary line γ3 (see FIG. 12) passes, for example, forms one end in the width direction of the electrode group 2, and a position through which an imaginary line γ4 (see FIG. 12) passes forms the other end in the width direction of the electrode group 2. In a preferable example, the groove 23 does not stick out to an outer side of the imaginary lines γ3 and γ4 in the width direction of the electrode group 2. In the example shown in FIGS. 12 and 13, the groove 23 does not stick out to either side relative to the concave portion strings 35A and 35B in the width direction.

As described above, in the preferable example of the present modification as shown in FIGS. 12-13, too, in a configuration in which the groove bottom 26 of the groove 23 neighbors the concave structure 30 from a side opposite to the protruding side of the current collecting bundle 12 in the length direction, the groove 23 (groove bottom 26) sticks out, beyond the concave structure 30, only to the side opposite to the protruding side of the current collecting bundle 12. The groove 23 does not stick out, beyond the concave structure 30, to the protruding side of the current collecting bundle 12, or to either side in the width direction.

Also, in the present modification, the groove bottom 26 of the groove 23 extends between concave portion strings 35A and 35B neighboring each other in the length direction of the electrode group 2. Thus, in the present modification, the plurality of concave portions 33 configuring the concave structure 30 includes two or more concave portions 33 distanced from each other in the length direction of the electrode group 2. The groove bottom 26 of the groove portion 23 extends between the two or more concave portions 33 distanced from each other in the length direction.

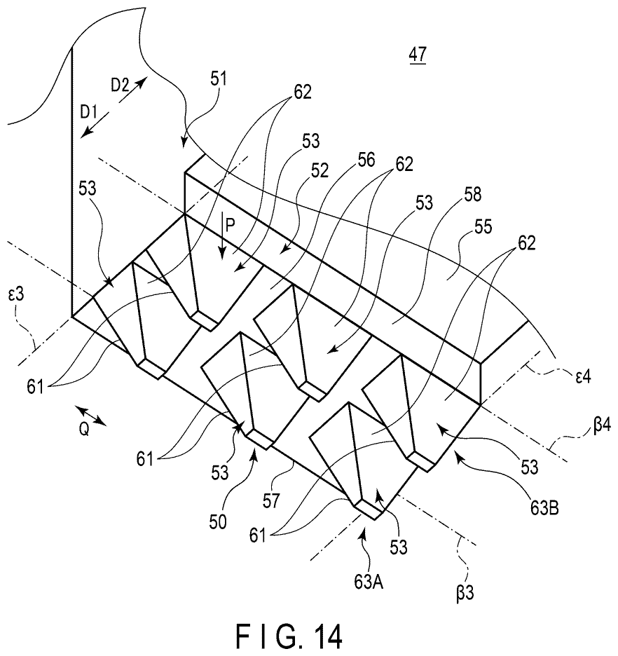

FIG. 14 is a perspective view schematically showing an example of a configuration of a joining tip portion 47 of a joining jig 41 according to the third modification. In the present modification, too, joining of the lead 17 to the current collecting bundle 12 is performed using a joining jig 41 in which a pedestal portion 56 forms a protruding end of a protruding stand 52 that protrudes from a base portion 51, and one or more projections 53 of a convex structure 50 further protrude from the pedestal portion 56 toward a protruding direction of the protruding stand 52, as shown in FIG. 14, etc. In the joining jig 41 used for joining, the pedestal portion 56 neighbors the convex structure 50 (projection string 63) from the side to which the stand side portion (first stand side portion) 57 in the depth direction of the protruding stand 52. The joining is performed in a similar manner to the above-described embodiment, etc., and in the joint part between the lead 17 and the current collecting bundle 12, the groove bottom 26 of the groove 23 is formed in a part with which the pedestal portion 56 is brought into contact, and a concave portion 33 is formed in each of the parts with which the one or more projections 53 of the convex structure 50 are brought into contact.

In a preferable example according to the third modification, too, the pedestal portion 56 and one or more projections 53 are brought into contact with the joined target part, with the pedestal portion 56 not sticking out, beyond the lead 17, to the protruding side of the current collecting bundle 12 in the length direction of the electrode group 2 or the side opposite to the protruding side of the current collecting bundle 12 in the length direction of the electrode group 2, either. In the example shown in FIG. 14, similarly to the first embodiment, etc., the convex structure 50 is configured of a plurality of projections 53 that are aligned along the width direction of the protruding stand 52 to form projection strings 63A and 63B.

However, in the present modification, a plurality of projection strings 63A and 63B are formed, and a plurality of projection strings 63A and 63B are displaced from each other in the depth direction of the protruding stand 52. With the above-described configuration, in the present modification as shown in FIG. 14, one or more projections 53 of the plurality of projections 53 are displaced from any one of the other projections 53 in the depth direction of the protruding stand 52. Accordingly, one or more projections 53 of the plurality of projections 53 have different separation distances from the stand side portion 57 relative to any one of the other projections 53 along the depth direction of the protruding stand 52.

Of the plurality of projections 53, a projection 53M (closest projection) closest to the stand side portion (first stand side portion) 57, and a projection (remotest projection) 53N most distanced from the stand side portion 57 are defined. In the configuration in which one or more projections 53 of the plurality of projections 53 are displaced from any one of the other projections 53 in the depth direction of the protruding stand 52, as in the present modification, the number of each of the projections 53M and 53N in the plurality of projections 53 is more than one. Depending on the arrangement of the plurality of projections 53 configuring the convex structure 50, the number of at least one of the projections 53M and 53N may be more than one. In the example shown in FIG. 14, three projections 53 forming the projection string 63A in the convex structure 50 function as the projection (closest projection) 53M, and three projections 53 forming the projection string 63B function as the projection (remotest projection) 53N. Note that the projection 53M is also referred to as a “first projection”, and the projection 53N is also referred to as a “second projection”. Of the plurality of projections 53, the projection 53M is most distanced from the stand side portion (second stand side portion) 58, and the projection 53N is closest to the stand side portion 58.

In the present modification, the pedestal portion 56 neighbors the convex structure 50 from the side to which the stand side portion (first stand side portion) 57 faces in the depth direction of the protruding stand 52, and therefore neighbors one or more projections 53 that function as the projection (closest projection) 53M, from the side to which the stand side portion 57 faces. The pedestal portion 56 sticks out, beyond the one or more projections 53 that function as the projection 53M, to the side to which the stand side portion 57 faces. In the example of FIG. 14, the pedestal portion 56 neighbors each of the three projections 53 forming the projection string 63A from the side to which the stand side portion 57 faces. Accordingly, in the present modification, too, the pedestal portion 56 extends to a region on the side to which the stand side portion 57 faces with respect to an end of the convex structure 50 on the side to which the stand side portion 57 faces. In the convex structure 50 according to the present modification, a position through which an imaginary line β3 (see FIG. 14) passes, for example, forms an end on the side to which the stand side portion 57 faces.

In a preferable example according to the present modification, the pedestal portion 56 does not stick out, beyond the convex structure 50, to the side to which the stand side portion (second stand side portion) 58 faces, and does not stick out, beyond one or more projections 53 that function as the projection (remotest projection) 53N, to the side to which the stand side portion 58 faces. In the example of FIG. 14, the pedestal portion 56 does not stick out, beyond any of the three projections 53 forming the projection string 63B, to the side to which the stand side portion 58 faces in the depth direction of the protruding stand 52. In the convex structure 50 according to the present modification, a position through which an imaginary line β4 (see FIG. 14) passes, for example, forms an end on the side to which the stand side portion 58 faces. In the present modification, each of the one or more projections 53 that function as the projection 53N is configured in such a manner that the projection side portion (second projection side portion) 62 is connected to the stand side portion (second stand side portion) 58 of the protruding stand 52 without the pedestal portion 56 being intervened in between.

In the preferable example as shown in FIG. 14 according to the present modification, too, the pedestal portion 56 does not stick out, beyond the convex structure 50, in the width direction of the protruding stand 52. Thus, the pedestal portion 56 is not formed in a region on an outer side of the convex structure 50 in the width direction of the protruding stand 52. In the convex structure 50 according to the present modification, for example, a position through which an imaginary line ε3 (see FIG. 14) passes forms one end in the width direction of the protruding stand 52, and a position through which an imaginary line ε4 (see FIG. 14) passes forms the other end in the width direction of the protruding stand 52. In a preferable example, the pedestal portion 56 does not stick out to an outer side of the imaginary lines ε3 and ε4 in the width direction of the protruding stand 52. In the example shown in FIG. 14, the pedestal portion 56 does not stick out to either side relative to each of the projection strings 63A and 63B in the width direction.

As described above, in the preferable example of the present modification as shown in FIG. 14, too, in a configuration in which the pedestal portion 56 neighbors the convex structure 50 from the side to which the stand side portion (first stand side portion) 57 faces in the depth direction of the protruding stand 52, the pedestal portion 56 sticks out beyond the convex structure 50 only to the side to which the stand side portion 57 faces. The pedestal portion 56 does not stick out, beyond the convex structure 50, to the side to which the stand side portion (second stand side portion) 58 faces, or to either side in the width direction of the protruding stand 52.

In the present modification, the pedestal portion 56 extends between projection strings 63A and 63B neighboring each other in the depth direction of the protruding stand 52. Thus, in the present modification, the plurality of projections 53 configuring the convex structure 50 include two or more projections 53 distanced from each other in the depth direction of the protruding stand 52. The pedestal portion 56 extends between the two or more projections 53 spaced apart in the depth direction.

The present modification produces advantageous effects similar to those of the above-described embodiment, etc. In the present modification, a joining jig 41 in which a pedestal portion 56 extends between two or more projections 53 distanced from each other in a depth direction of a protruding stand 52 is used for joining. This allows the groove bottom 26 of the groove 23 to extend between two or more concave portions 33 distanced from each other in the length direction of the electrode group 2 in the joint part. By performing joining with the pedestal portion 56 brought into contact with the joined target part between the concave portions 33 distanced from each other, the bonding strength at the joint part is further improved.

In a modification, three or more concave portion strings 35 each including a plurality of concave portions 33 that are aligned along the width direction of the electrode group 2 are formed in the concave structure 30. In this case, too, one or more concave portions 33 of the plurality of concave portions 33 are displaced from any one of the other concave portions 33 in the length direction of the electrode group 2. In the present modification, too, concave portions 33M and 33N are defined similarly to the third modification. Also, a groove 23 and one or more concave portions 33 are formed in a joint part between the current collecting bundle 12 and the lead 17, similarly to any one of the examples described above in the third modification. However, in either case, the groove bottom 26 of the groove 23 neighbors the concave structure 30 from a side opposite to the protruding side of the current collecting bundle 12 in the length direction of the electrode group 2, and neighbors the concave portion 33M from the side opposite to the protruding side of the current collecting bundle 12.

In the present modification, three or more projection strings 63 each including a plurality of projections 53 that are aligned along the width direction of the protruding stand 52 are formed in the joining jig 41. In this case, too, one or more projections 53 of the plurality of projections 53 are displaced from any one of the other projections 53 in the depth direction of the protruding stand 52. In the present modification, too, projections 53M and 53N are defined similarly to the third modification. A pedestal portion 56 and one or more projections 53 are formed in a joining tip portion 47, similarly to any one of the examples described above in the third modification. However, in either case, the pedestal portion 56 neighbors the convex structure 50 from the side to which the stand side portion (first stand side portion) 57 faces in the depth direction of the protruding stand 52, and neighbors the projection 53M from the side to which the stand side portion 57 faces.

In a modification, in a configuration in which a concave portion string 35 including a plurality of concave portions 33 that are aligned along the width direction of the electrode group 2 is not formed in a concave structure 30, one or more concave portions 33 of the plurality of concave portions 33 are displaced from any one of the other concave portions 33 in the length direction of the electrode group 2. In the present modification, too, concave portions 33M and 33N are defined similarly to the third modification. Also, a groove 23 and one or more concave portions 33 are formed in a joint part between the current collecting bundle 12 and the lead 17, similarly to any one of the examples described in the third modification. However, in either case, the groove bottom 26 of the groove 23 neighbors the concave structure 30 from a side opposite to the protruding side of the current collecting bundle 12 in the length direction of the electrode group 2, and neighbors the concave portion 33M from the side opposite to the protruding side of the current collecting bundle 12.

In the present modification, a projection string 63 including a plurality of projections 53 that are aligned along the width direction of the protruding stand 52 is not formed in the joining jig 41. However, in the present modification, too, one or more projections 53 of the plurality of projections 53 are displaced from any one of the other projections 53 in the depth direction of the protruding stand 52, and projections 53M and 53N are defined similarly to the third modification. A pedestal portion 56 and one or more projections 53 are formed in a joining tip portion 47, similarly to any one of the examples described above in the third modification. However, in either case, the pedestal portion 56 neighbors the convex structure 50 from the side to which the stand side portion (first stand side portion) 57 faces in the depth direction of the protruding stand 52, and neighbors the projection 53M from the side to which the stand side portion 57 faces.

In a modification, a plurality of concave portions 33 forming the concave structure 30 includes two or more concave portions 33 distanced from each other in both the length direction and the width direction of the electrode group 2. The groove bottom 26 of the groove 23 extends between the two or more concave portions 33 distanced from each other. In the present modification, a joining jig 41 is configured in such a manner that each of a plurality of projections 53 forming a convex structure 50 includes two or more projections 53 distanced from each other in both the depth direction and the width direction of the protruding stand 52. The pedestal portion 56 extends between the two or more projections 53 distanced from each other.

Accordingly, in an example of the embodiment, etc., two or more concave portions of the plurality of concave portions 33 forming the concave structure 30 are distanced from each other in at least one of the length direction and the width direction of the electrode group 2, and the groove bottom 26 of the groove 23 extends between two or more concave portions 33 distanced from each other. Two or more projections 53 of the plurality of projections 53 forming the convex structure 50 are distanced from each other in at least one of the depth direction and the width direction of the protruding stand 52, and the pedestal portion 56 extends between two or more projections 53 distanced from each other.

In a modification, a plurality of current collecting bundles 12 are formed in each of the paired uncoated parts 11. In this case, in each of the paired uncoated parts 11, the plurality of current collecting bundles 12 are distanced from each other in a thickness direction of the electrode group 2. In the case where a plurality of current collecting bundles 12 are formed in each of the uncoated parts 11, each of the current collecting bundles 12 protrudes toward one side in the length direction of the electrode group 2, and a plurality of current collecting strips 13 are stacked in each current collecting bundle 12 in the thickness direction of the electrode group 2. In the present modification, a plurality of leg plates 22 are provided in each of the leads 17, in which the same number of leg plates 22 as the number of current collecting bundles 12 formed in the uncoated part 11 to which the connection is made are provided. In the present modification, each of the current collecting bundles 12 is joined to a corresponding one of a pair of leads 17 via a corresponding one of the leg plates 22. In the present modification, too, each of the current collecting bundles 12 is joined to the leg plate 22, similarly to the above-described embodiment, etc.

In a modification, a clip 18 is not provided in the battery 1, and a clip 18 is not attached to each of the current collecting bundles 12. In this case, in each of the paired uncoated parts 11, the current collecting bundle 12 is directly joined (connected) to a corresponding one of the paired leads 17. In the present modification, on an outer surface of the current collecting bundle 12, the groove 23 opens to a side opposite to the stacking side of the lead 17 in the thickness direction of the electrode group 2. In the present modification, too, each of the current collecting bundles 12 is joined to the lead 17, similarly to the above-described embodiment, etc.

In the above-described embodiment, etc., an exterior unit 3 is configured of an exterior container 5 and a lid member 6; however, the configuration, etc. of the exterior unit 3 is not limited thereto. In a modification, the exterior unit 3 is configured of a laminate film.

In the example of FIG. 1, etc., the paired uncoated parts 11 protrude to an opposite side to each other in the length direction of the electrode group 2; however, the configuration is not limited thereto. In a modification, in the electrode group 2, a negative-electrode uncoated part protrudes toward a protruding side of the positive-electrode uncoated part in the length direction. In this case, the paired uncoated parts 11 are distanced from each other in the width direction of the electrode group 2, and do not contact each other. In an example according to the present modification, the electrode group 2 is disposed in an inner cavity 10 of the exterior container 5, with the thickness direction of the electrode group 2 extending along a depth direction of the battery 1, a length direction of the electrode group 2 extending along a height direction of the battery 1, and a width direction of the electrode group 2 extending along the lateral direction of the battery 1. In the inner cavity 10, the paired uncoated parts 11 (the positive-electrode uncoated part and the negative-electrode uncoated part) protrude toward the side on which the lid member 6 is located in the height direction of the battery 1. In the present modification, too, each of the current collecting bundles 12 is joined to the lead 17 in each of the uncoated parts 11, similarly to the above-described embodiment, etc.

In either of the above-described modifications, the joint part in which the current collecting bundle 12 is joined to the lead 17 is configured in such a manner that the groove bottom 26 of the groove 23 neighbors the concave structure 30 from a side opposite to the protruding side of the current collecting bundle 12 in the length direction of the electrode group 2. In the joining jig 41 used for joining of the current collecting bundle 12 to the lead 17, the pedestal portion 56 neighbors the convex structure 50 from a side to which the stand side portion (first stand side portion) 57 faces in the depth direction of the protruding stand 52.

In the electrode group 2, it suffices that at least one of the paired uncoated parts 11, namely, at least one of the positive-electrode uncoated part or the negative-electrode uncoated part is joined to the lead 17, similarly to any one of the embodiments described above. That is, it suffices that one or more pairs of current collecting bundles 12 formed in the electrode group 2 are joined to the lead 17, similarly to one of the above-described embodiments, etc.

According to at least one embodiment or example, the groove is depressed toward the side on which the lead is located in the thickness direction in the joint part between the lead and the current collecting bundle, and one or more concave portions of the concave structure are further depressed from the groove bottom of the groove toward the side on which the lead is located. Also, the groove bottom of the groove neighbors the concave structure from a side opposite to the protruding side of the current collecting bundle in the length direction. It is thereby possible to provide a battery, a joining jig, a joining apparatus, and a manufacturing method of a battery capable of ensuring suitable joining at a region that neighbors a concave structure on a side opposite to a protruding side of a current collecting bundle in a joint part between a lead and the current collecting bundle.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A battery, comprising:
an electrode group including a current collecting bundle protruding toward one side in a length direction;
a lead having electrical conductivity and joined to the current collecting bundle in a state of being stacked on the current collecting bundle from one side in a thickness direction of the electrode group crossing the length direction;
a groove including a groove bottom and depressed to the groove bottom toward a side on which the lead is located in the thickness direction in a joint part between the lead and the current collecting bundle; and
a concave structure including one or more concave portions each further depressed from the groove bottom of the groove toward the side on which the lead is located, the groove bottom of the groove neighboring the concave structure from a side opposite to a protruding side of the current collecting bundle in the length direction.

2. The battery according to claim 1, wherein
the groove does not stick out, beyond the lead, to either the protruding side of the current collecting bundle in the length direction, or the side opposite to the protruding side of the current collecting bundle in the length direction.

3. The battery according to claim 1, wherein
the groove does not stick out, beyond the concave structure, to the protruding side of the current collecting bundle in the length direction.

4. The battery according to claim 1, wherein
the groove does not stick out, beyond the concave structure, in a width direction of the electrode group crossing both the length direction and the thickness direction.

5. The battery according to claim 1, wherein
the concave structure includes a plurality of concave portions as the one or more concave portions,
the plurality of concave portions include two or more concave portions distanced from each other in at least one of the length direction and a width direction of the electrode group crossing both the length direction and the thickness direction, and
the groove bottom of the groove extends between the two or more concave portions distanced from each other.

6. A joining jig, comprising:
a base portion;
a protruding stand protruding from the base portion, and including a pedestal portion forming a protruding end from the base portion, and a first stand side portion extending toward a protruding direction from the base portion while facing one side in a depth direction crossing the protruding direction; and
a convex structure including one or more projections further protruding from the pedestal portion toward the protruding direction of the protruding stand, the convex structure being neighbored by the pedestal portion from a side to which the first stand side portion faces in the depth direction of the protruding stand.

7. The joining jig according to claim 6, wherein
the protruding stand includes a second stand side portion extending toward the protruding direction from the base portion in a state of facing a side opposite to the side to which the first stand side portion faces in the depth direction, and
the pedestal portion does not stick out, beyond the convex structure, to a side to which the second stand side portion faces in the depth direction of the protruding stand.

8. The joining jig according to claim 6, wherein
the pedestal portion of the protruding stand does not stick out, beyond the convex structure, in a width direction of the protruding stand crossing both the protruding direction and the depth direction.

9. The joining jig according to claim 6, wherein
the base portion includes a base surface facing the protruding direction,
the protruding stand includes a second stand side portion extending toward the protruding direction from the base surface of the base portion in a state of facing a side opposite to the side to which the first stand side portion faces in the depth direction,
the base surface is located on a side to which the second stand side portion faces in the depth direction, with respect to the convex structure, and
a protrusion length along the protruding direction from the base surface of the base portion to a protruding end of the one or more projections of the convex structure is greater than a protrusion length along the protruding direction from the pedestal portion of the protruding stand to a protruding end of the one or more projections of the convex structure.

10. The joining jig according to claim 6, wherein
the convex structure includes a plurality of projections as the one or more projections,
the plurality of projections include two or more projections distanced from each other in at least one of the depth direction or a width direction of the protruding stand crossing both the protruding direction and the depth direction, and
the pedestal portion of the protruding stand extends between the two or more projections distanced from each other.

11. A joining apparatus, comprising:
the joining jig according to claim 6;
a stage configured, in joining of a current collecting bundle protruding toward one side in a length direction in an electrode group to a lead, to interpose a joined target part in which the current collecting bundle and the lead are stacked, between the stage and the joining jig, with the lead stacked on the current collecting bundle from one side in a thickness direction of the electrode group crossing the length direction, and configured to be brought into contact with the joined target part from a stacking side of the lead in the thickness direction;
a pressuring unit configured to bring the pedestal portion and the one or more projections of the convex structure of the joining jig into contact with the joined target part, with the first stand side portion facing a side opposite to a protruding side of the current collecting bundle in the length direction, by applying a pressure to at least one of the joining jig and the stage, with the joined target part interposed between the joining jig and the stage; and
an ultrasonic transducer configured to transmit ultrasonic vibration to the joined target part through the joining jig, with the joined target part interposed between the joining jig and the stage.

12. A manufacturing method of a battery, comprising:
stacking, in an electrode group in which a current collecting bundle protrudes toward one side in a length direction, a lead on the current collecting bundle from one side in a thickness direction of the electrode group crossing the length direction;
joining a joined target part in which the current collecting bundle and the lead are stacked, by using a joining jig in which a pedestal portion forms a protruding end of a protruding stand protruding from a base portion, and one or more projections of a convex structure further protrude from the pedestal portion toward a protruding direction of the protruding stand, the joining being performed using the joining jig in which a first stand side portion of the protruding stand extends toward the protruding direction from the base portion while facing one side in a depth direction of the protruding stand crossing the protruding direction, and the convex structure is neighbored by the pedestal portion from a side to which the first stand side portion faces in the depth direction; and
bringing the pedestal portion and the one or more projections of the convex structure of the joining jig into contact with the joined target part from a side opposite to a stacking side of the lead in the thickness direction, with the first stand side portion facing a side opposite to a protruding side of the current collecting bundle in the length direction in the joining of the joined target part.

13. The manufacturing method according to claim 12, wherein
the pedestal portion and the one or more projections are brought into contact with the joined target part in such a manner that the pedestal portion does not stick out, beyond the lead, to either the protruding side of the current collecting bundle in the length direction or the side opposite to the protruding side of the current collecting bundle in the length direction.

14. The manufacturing method according to claim 12, wherein
in the joining jig used for joining of the joined target part, a second stand side portion of the protruding stand extends toward the protruding direction from the base portion while facing a side opposite to the side to which the first stand side portion faces in the depth direction, and the pedestal portion does not stick out, beyond the convex structure, to a side to which the second stand side portion faces in the depth direction of the protruding stand.

15. The manufacturing method according to claim 12, wherein
in the joining jig used for joining of the joined target part, the pedestal portion does not stick out, beyond the convex structure, in a width direction of the protruding stand crossing both the protruding direction and the depth direction.
